(19) United States
(12) Patent Application Publication
(10) Pub. No.: US 2018/0083824 A1
(43) Pub. Date: Mar. 22, 2018

(54) NESTED CONSTELLATION TECHNIQUES FOR PAYLOAD-TAPERING, EMBEDDED CONTROL, OR REFERENCE SIGNAL TRANSMISSIONS

(71) Applicant: QUALCOMM Incorporated, San Diego, CA (US)

(72) Inventors: Yang Yang, San Diego, CA (US); Jing Jiang, San Diego, CA (US); Alexandros Manolakos, San Diego, CA (US); Santosh Paul Abraham, San Diego, CA (US)

(21) Appl. No.: 15/612,562

(22) Filed: Jun. 2, 2017

Related U.S. Application Data
(60) Provisional application No. 62/398,353, filed on Sep. 22, 2016.

(51) Int. Cl. H04L 27/38; H04L 27/22; H04W 72/04; H04B 1/10; H04L 1/00

(52) U.S. Cl. CPC H04L 27/38; H04L 27/22; H04W 16/14; H04B 1/1027; H04L 1/0003; H04W 72/0446

(57) ABSTRACT

Techniques are described that provide nested constellations in which a lower order modulation scheme may be nested within constellation points of a higher-order modulation scheme. A higher-order modulation scheme, having a first constellation, may be used for a first subset of transmissions (e.g., data payload transmissions). A lower-order modulation scheme, having a second constellation, may be used for a second subset of transmissions (e.g., reference signal transmissions, embedded control transmissions, tapered payload transmissions, etc.). A subset of constellation points of the first constellation may be selected for transmitting the second subset of transmissions. A receiver may receive the transmissions and demodulate/decode the transmissions. In the event that other transmitters are transmitting concurrently, and using similar nested constellation techniques, the receiver may be able to perform improved interference mitigation compared to interference mitigation that may be performed on interfering signals that use different constellation points.

### CROSS REFERENCES

The present application for patent claims priority to U.S. Provisional Patent Application No. 62/398,353 by Yang, et al., entitled “NESTED CONSTELLATION TECHNIQUES FOR PAYLOAD-TAPERING, EMBEDDED CONTROL, OR REFERENCE SIGNAL TRANSMISSIONS,” filed Sep. 22, 2016, assigned to the assignee hereof.

### INTRODUCTION

The following relates generally to wireless communication, and more specifically to nested constellation techniques for payload-tapering, embedded control, or reference signal transmissions.

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

In some examples, a wireless multiple-access communication system may include a number of base stations, each simultaneously supporting communication for multiple communication devices, otherwise known as user equipment (UEs). In a Long-Term Evolution (LTE) or LTE-Advanced (LTE-A) network, a set of one or more base stations may define an eNodeB (eNB). In other examples (e.g., in a next generation or 5G network), a wireless multiple access communication system may include a number of next generation NodeBs (gNBs) which in some cases may include smart radio heads (radio heads (RHs)) in communication with a number of access node controllers (ANCs). A base station may communicate with a set of UEs on downlink (DL) channels (e.g., for transmissions from a base station to a UE) and uplink (UL) channels (e.g., for transmissions from a UE to a base station).

Subframes of communication between a network access device (e.g., a gNB, an eNB, an ANC, a RH, or a base station) and a plurality of UEs may include different regions or channels that are assembled in accordance with a time division duplex (TDD) and/or frequency division duplex (FDD) subframe or slot structure. Subframes may include arrangements of UL channels and/or DL channels in which downlink or uplink data transmissions, reference signal transmissions, control transmissions, or any combination thereof, may be transmitted. The transmissions in the UL and/or DL channels may include information modulated using a particular modulation scheme that is used to transmit a modulation symbol. For example, a quadrature phase shift keying (QPSK) modulation scheme may provide two bits of information per modulation symbol, and a 16 quadrature amplitude modulation (QAM) modulation scheme may provide four bits of information per modulation symbol. In some cases, different UL and/or DL transmissions within a subframe may use different modulation schemes. For example, data may be transmitted using a higher modulation scheme (e.g., 16 QAM or 64 QAM) than an embedded control or reference signal transmission modulation scheme (e.g., QPSK). Such different modulation schemes require receivers to modify demodulation and decoding techniques for received transmissions, and simplification of such techniques may enhance the operation of a wireless multiple-access communication system.

### SUMMARY

A method of wireless communication is described. The method may include identifying a first modulation scheme having a first constellation for a first subset of transmissions in a transmission time interval (TTI) or in a slot, identifying a second modulation scheme having a second constellation for a second subset of transmissions in the TTI, the second constellation having fewer constellation points than the first constellation, selecting a subset of constellation points of the first constellation for transmitting the second subset of transmissions, the subset of constellation points corresponding to one or more constellation points of the first modulation scheme and having an average power that is the same or similar to an average constellation point power of the first constellation, and transmitting the first subset of transmissions using the first modulation scheme and the second subset of transmissions using the selected subset of constellation points of the first constellation.

An apparatus for wireless communication is described. The apparatus may include means for identifying a first modulation scheme having a first constellation for a first subset of transmissions in a TTI, means for identifying a second modulation scheme having a second constellation for a second subset of transmissions in the TTI, the second constellation having fewer constellation points than the first constellation, means for selecting a subset of constellation points of the first constellation for transmitting the second subset of transmissions, the subset of constellation points corresponding to one or more constellation points of the first modulation scheme and having an average power that is the same or similar to an average constellation point power of the first constellation, and means for transmitting the first subset of transmissions using the first modulation scheme and the second subset of transmissions using the selected subset of constellation points of the first constellation.

Another apparatus for wireless communication is described. The apparatus may include a processor, memory in electronic communication with the processor, and instructions stored in the memory. The instructions may be operable to cause the processor to identify a first modulation scheme having a first constellation for a first subset of transmissions in a TTI, identify a second modulation scheme having a second constellation for a second subset of transmissions in the TTI, the second constellation having fewer constellation points than the first constellation, select a subset of constellation points of the first constellation for transmitting the second subset of transmissions, the subset of constellation points corresponding to one or more constellation points of the first modulation scheme and having an average power that is the same or similar to an average constellation point power of the first constellation, and transmit the first subset of transmissions using the first modulation scheme and the second subset of transmissions using the selected subset of constellation points of the first constellation.

A non-transitory computer-readable medium for wireless communication is described. The non-transitory computer-readable medium may include instructions operable to cause a processor to identify a first modulation scheme having a first constellation for a first subset of transmissions in a TTI, identify a second modulation scheme having a second constellation for a second subset of transmissions in the TTI, the second constellation having fewer constellation points than the first constellation, select a subset of constellation points of the first constellation for transmitting the second subset of transmissions, the subset of constellation points corresponding to one or more constellation points of the first modulation scheme and having an average power that is the same or similar to an average constellation point power of the first constellation, and transmit the first subset of transmissions using the first modulation scheme and the second subset of transmissions using the selected subset of constellation points of the first constellation.

In some examples of the method, apparatus, and non-transitory computer-readable medium described above, the subset of constellation points having an average power that is the same or similar to an average constellation point power of the first constellation provides for enhanced interference mitigation at a receiver relative to constellation points of the first constellation having a substantially different power than the average constellation point power of the first constellation.

In some examples of the method, apparatus, and non-transitory computer-readable medium described above, the first subset of transmissions comprise data transmissions and the second subset of transmissions comprise a payload-tapered transmission.

In some examples of the method, apparatus, and non-transitory computer-readable medium described above, the first subset of transmissions comprise data transmissions, and the second subset of transmissions comprise one or more of a reference signal transmission, a control signal transmission, or any combination thereof.

In some examples of the method, apparatus, and non-transitory computer-readable medium described above, the identifying the first modulation scheme comprises determining that the first subset of transmissions is to be transmitted using a 16 quadrature amplitude multiplexing (QAM) or higher modulation scheme. In some examples of the method, apparatus, and non-transitory computer-readable medium described above, the identifying the second modulation scheme comprises determining and the second subset of transmissions is to be transmitted using a quadrature phase shift keying (QPSK) modulation scheme.

In some examples of the method, apparatus, and non-transitory computer-readable medium described above, the first modulation scheme is a 16 QAM modulation scheme, and the selecting the subset of constellation points of the first constellation comprises: identifying constellation points of the 16 QAM modulation scheme that have a same power as an average power of the first constellation as the subset of constellation points of the first constellation. Some examples of the method, apparatus, and non-transitory computer-readable medium described above may further include processes, features, means, or instructions for phase rotating constellation points of the QPSK modulation scheme to match the subset of constellation points.

In some examples of the method, apparatus, and non-transitory computer-readable medium described above, the first modulation scheme is a 64 QAM modulation scheme, and the selecting the subset of constellation points of the first constellation comprises: identifying constellation points of the 64 QAM modulation scheme that have a power closest to an average power of the first constellation as the subset of constellation points of the first constellation. Some examples of the method, apparatus, and non-transitory computer-readable medium described above may further include processes, features, means, or instructions for determining if constellation points of the QPSK modulation scheme do not match the subset of constellation points. Some examples of the method, apparatus, and non-transitory computer-readable medium described above may further include processes, features, means, or instructions for phase rotating, based at least in part on the determining, the constellation points of the QPSK modulation scheme to match the subset of constellation points.

In some examples of the method, apparatus, and non-transitory computer-readable medium described above, the identifying constellation points of the 64 QAM modulation scheme comprises: identifying a first subset of constellation points of the 64 QAM modulation scheme and a second subset of constellation points of the 64 QAM modulation scheme that have a combined average power that is the same as an average power of the first constellation, selecting the first subset of constellation points of the 64 QAM modulation scheme for a first portion of the second subset of transmissions, and selecting the second subset of constellation points of the 64 QAM modulation scheme for a second portion of the second subset of transmissions. In some examples of the method, apparatus, and non-transitory computer-readable medium described above, the first portion of the second subset of transmissions and the second portion of the second subset of transmissions may be transmitted using alternating frequency tones of the second subset of transmissions.

In some examples of the method, apparatus, and non-transitory computer-readable medium described above, the first modulation scheme is a 64 QAM modulation scheme and the second modulation scheme is a 16 QAM modulation scheme, and the selecting the subset of constellation points of the first constellation comprises: identifying constellation points of the 64 QAM modulation scheme that have a power closest to an average power of the first constellation as the subset of constellation points of the first constellation. Some examples of the method, apparatus, and non-transitory computer-readable medium described above may further include processes, features, means, or instructions for determining if constellation points of the 16 QAM modulation scheme do not match the subset of constellation points. Some examples of the method, apparatus, and non-transitory computer-readable medium described above may further include processes, features, means, or instructions for phase rotating, based at least in part on the determining, the constellation points of the 16 QAM modulation scheme to match the subset of constellation points.

In some examples of the method, apparatus, and non-transitory computer-readable medium described above, the method may be performed by a base station and the first subset of transmissions and the second subset of transmissions may be transmitted to a user equipment. In some examples of the method, apparatus, and non-transitory computer-readable medium described above, the method may be performed by a UE and the first subset of transmissions and the second subset of transmissions may be transmitted to a base station or another UE.

### BRIEF DESCRIPTION OF THE DRAWINGS

FIG. 1 illustrates an example of a system for wireless communication that supports nested constellation techniques for payload-tapering, embedded control, or reference signal transmissions in accordance with one or more aspects of the present disclosure.

FIG. 2 illustrates an example of a wireless communication system that supports nested constellation techniques for payload-tapering, embedded control, or reference signal transmissions in accordance with one or more aspects of the present disclosure.

FIG. 3A illustrates an example of a nominal downlink-centric subframe that supports nested constellation techniques for payload-tapering, embedded control, or reference signal transmissions in accordance with one or more aspects of the present disclosure.

FIG. 3B illustrates an example of a nominal uplink-centric subframe that supports nested constellation techniques for payload-tapering, embedded control, or reference signal transmissions in accordance with one or more aspects of the present disclosure.

FIGS. 4A through 4D illustrate examples of downlink-centric subframes that include payload-tapered symbols, embedded control symbols, or reference signal symbols in accordance with one or more aspects of the present disclosure.

FIGS. 5A through 5D illustrate examples of uplink-centric subframes that include payload-tapered symbols, embedded control symbols, or reference signal symbols in accordance with one or more aspects of the present disclosure.

FIG. 6 illustrates an example of a downlink subframe and interfering concurrent other downlink subframes in accordance with one or more aspects of the present disclosure.

FIG. 7 illustrates an example of different modulation constellations that support nested constellation techniques for payload-tapering, embedded control, or reference signal transmissions in accordance with one or more aspects of the present disclosure.

FIG. 8 illustrates an example of a 16 QAM constellation that supports nested constellation techniques for payload-tapering, embedded control, or reference signal transmissions in accordance with one or more aspects of the present disclosure.

FIG. 9 illustrates an example of a 64 QAM constellation that supports nested constellation techniques for payload-tapering, embedded control, or reference signal transmissions in accordance with one or more aspects of the present disclosure.

FIG. 10 illustrates another example of a 64 QAM constellation that supports nested constellation techniques for payload-tapering, embedded control, or reference signal transmissions in accordance with one or more aspects of the present disclosure.

FIG. 11 illustrates an example of a process flow that supports nested constellation techniques for payload-tapering, embedded control, or reference signal transmissions in accordance with one or more aspects of the present disclosure.

FIGS. 12 through 14 show block diagrams of a device that supports nested constellation techniques for payload-tapering, embedded control, or reference signal transmissions in accordance with one or more aspects of the present disclosure.

FIG. 15 illustrates a block diagram of a system including a UE that supports nested constellation techniques for payload-tapering, embedded control, or reference signal transmissions in accordance with one or more aspects of the present disclosure.

FIG. 16 illustrates a block diagram of a system including a base station that supports nested constellation techniques for payload-tapering, embedded control, or reference signal transmissions in accordance with one or more aspects of the present disclosure.

FIGS. 17 through 20 illustrate methods for nested constellation techniques for payload-tapering, embedded control, or reference signal transmissions in accordance with one or more aspects of the present disclosure.

### DETAILED DESCRIPTION

Techniques are described that provide nested constellations in which a lower order modulation scheme may be nested within constellation points of a higher-order modulation scheme. A higher-order modulation scheme, having a first constellation, may be used for a first subset of transmissions (e.g., data payload transmissions) in a transmission time interval (TTI). A lower-order modulation scheme, having a second constellation, may be used for a second subset of transmissions (e.g., reference signal transmissions, embedded control transmissions, tapered payload transmissions, etc.) in the TTI. In some examples, a subset of constellation points of the first constellation may be selected for transmitting the second subset of transmissions. A receiver (e.g., a base station or UE that receives the transmissions) may receive the transmissions and demodulate/decode the transmissions. In the event that other transmitters are transmitting concurrently, and using similar nested constellation techniques, the receiver may be able to perform improved interference mitigation compared to interference mitigation that may be performed on interfering signals that use different constellation points.

The present disclosure describes various techniques with reference to next generation networks (e.g., 5G or new radio (NR) networks) that are being designed to support features such as high bandwidth operations, more dynamic subframe types, and self-contained subframe types (in which hybrid automatic repeat request (HARD) feedback for a subframe may be transmitted before the end of the subframe). However, such techniques may be used for any systems in which transmissions may be subject to potential interfering transmissions. In systems where potential interfering transmissions may be present from concurrent transmissions of other nodes of the same system (or other nodes of a different system that operates according to techniques described herein), various interference estimation, suppression, and/or cancellation techniques may be used to mitigate the interfering transmission. Interference mitigation techniques in such system may be enhanced if the interfering transmissions have relatively little power variation across different data symbols within a subframe, have relatively little constellation variation across different data symbols within a subframe, and have relatively little precoding matrix variation different data symbols within a subframe. For example, if the interfering symbols have little or no power variation, there will be little or no mismatch in interference estimation from symbol to symbol. If the interfering symbols have little or no constellation variation, some advanced receivers may be able to perform constellation detection and use sophisticated interference cancellation techniques.

In cases, however, where interfering symbols could have various different configurations, such as different constellations and different power, such interference mitigation techniques may be less effective. Furthermore, if power and/or constellation type vary from symbol-to-symbol within a subframe, an interference mitigation technique that is established for a first symbol may be less effective or ineffective for a subsequent symbol that has a different power, different constellation, or both. In some examples, different UEs transmitting within a same cell may have different configurations. Techniques provided herein provide the ability to maintain the same or similar constellations between symbols and across devices, and thereby allow for enhanced mitigation techniques to be employed when multiple transmitters have concurrent transmissions.

As indicated above, within a subframe different symbols may carry different types of information and use different modulation orders. For example, reference signal transmissions may be transmitted using quadrature phase shift keying (QPSK), embedded control transmissions may use QPSK, and data payload transmissions may use 16 quadrature amplitude multiplexing (QAM) or 64 QAM. Furthermore, some UEs may use payload tapering, in which one or more symbols of a subframe include a smaller amount of data in order to allow faster processing of the data and maintain timelines for providing a response to the data reception (e.g., ACK/NACK feedback). In cases where payload tapering is used, the payload tapered symbols may use a different modulation constellation than a non-tapered data payload symbol. Furthermore, different UEs may use different combinations of symbols with different constellations, which may impact interference mitigation at other UEs receiving other concurrent transmissions. The various aspects as briefly discussed above, and as will be described in more detail below, provide that lower-order constellations may be nested within a higher-order constellation and have a constellation power that is the same or similar to an average constellation power of the higher-order constellation. Thus, other UEs receiving other concurrent transmissions may take full advantage of interference mitigation techniques, which may help increase the overall efficiency of the system.

Aspects of the disclosure are initially described in the context of a wireless communications system. Various examples of uplink-centric (UL-centric) and downlink-centric (DL-centric) subframes, and nested constellation techniques are also described. Aspects of the disclosure are further illustrated by and described with reference to apparatus diagrams, system diagrams, and flowcharts that relate to nested constellation techniques for payload-tapering, embedded control, or reference signal transmissions.

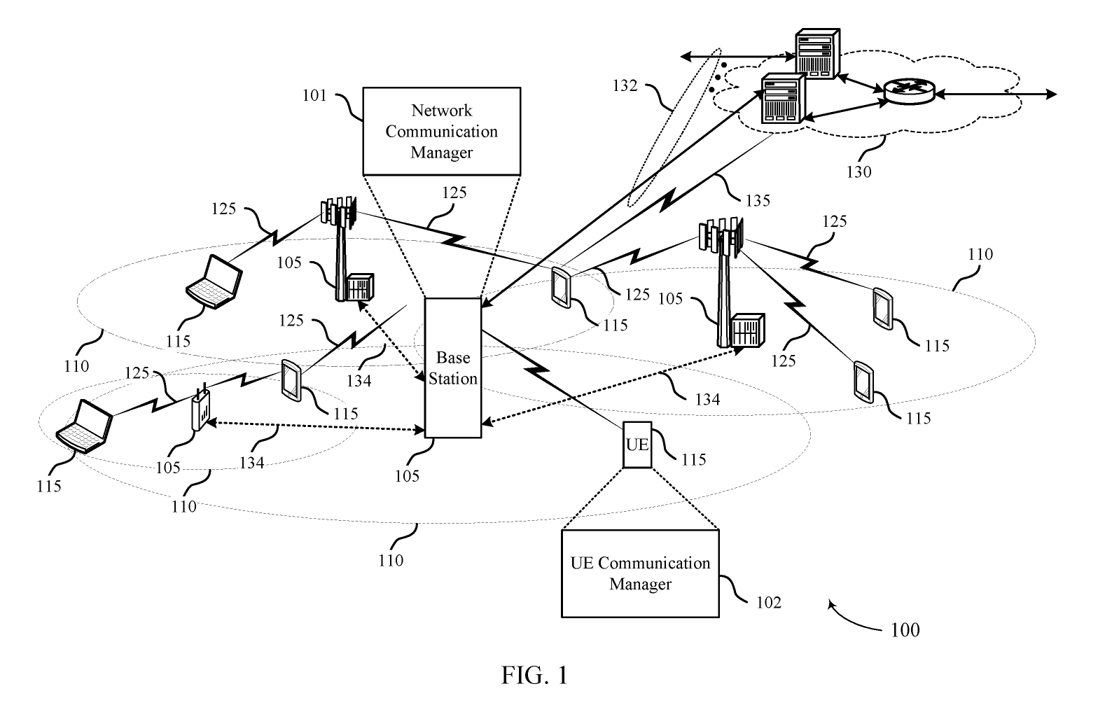

FIG. 1 illustrates an example of a wireless communications system 100 in accordance with one or more aspects of the present disclosure. The wireless communications system 100 includes base stations 105 (e.g., gNodeBs (gNBs), network access devices, access node controllers (ANCs) and/or radio heads (RHs)), UEs 115, and a core network 130. In some examples, the wireless communications system 100 may be a Long-Term Evolution (LTE) (or LTE-Advanced (LTE-A)) network. Wireless communication system 100 may support nested constellation techniques for payload-tapering transmissions, embedded control transmissions, reference signal transmissions, or any combination thereof.

The core network 130 may provide user authentication, access authorization, tracking, Internet Protocol (IP) connectivity, and other access, routing, or mobility functions. At least some of the base stations 105 (e.g., network access devices, gNBs, ANCs, RHs) may interface with the core network 130 through backhaul links 132 (e.g., S1, S2, etc.) and may perform radio configuration and scheduling for communication with the UEs 115. In various examples, ANCs may communicate, either directly or indirectly (e.g., through core network 130), with each other over backhaul links 134 (e.g., X1, X2, etc.), which may be wired or wireless communication links. Each ANC may additionally or alternatively communicate with a number of UEs 115 through a number of smart radio heads. In an alternative configuration of the wireless communication system 100, the functionality of an ANC may be provided by a radio head or distributed across the radio heads of a gNB.

In some examples, the wireless communication system 100 may include a 5G network. In other examples, the wireless communication system 100 may include a LTE/LTE-A network. The wireless communication system 100 may in some cases be a heterogeneous network, in which different types of base stations 105 (e.g., gNBs, eNBs, ANCs, etc.) provide coverage for various geographical regions. The term “cell” is a 3GPP term that can be used to describe a base station, a radio head, a carrier or component carrier associated with a base station or a radio head, or a coverage area (e.g., sector, etc.) of a carrier or base station, depending on context.

Base stations 105 may wirelessly communicate with UEs 115 via one or more base station antennas. Each base station 105 may provide communication coverage for a respective geographic coverage area 110. Communication links 125 shown in wireless communications system 100 may include uplink transmissions from a UE 115 to a base station 105, or downlink transmissions, from a base station 105 to a UE 115. A UE 115 may communicate with the core network 130 through communication link 135. UEs 115 may be dispersed throughout the wireless communications system 100, and each UE 115 may be stationary or mobile.

The communication networks that may accommodate some of the various disclosed examples may be packet-based networks that operate according to a layered protocol stack. In the user plane, communications at the bearer or Packet Data Convergence Protocol (PDCP) layer may be IP-based. A Radio Link Control (RLC) layer may in some cases perform packet segmentation and reassembly to communicate over logical channels. A Medium Access Control (MAC) layer may perform priority handling and multiplexing of logical channels into transport channels. The MAC layer may additionally or alternatively use HARQ to provide retransmission at the MAC layer to improve link efficiency. In the control plane, the Radio Resource Control (RRC) protocol layer may provide establishment, configuration, and maintenance of an RRC connection between a UE 115 and a base station 105, or core network 130 supporting radio bearers for user plane data. At the Physical (PHY) layer, transport channels may be mapped to physical channels.

The UEs 115 may be dispersed throughout the wireless communication system 100, and each UE 115 may be stationary or mobile. A UE 115 may additionally or alternatively include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, an Internet of things (IoT) device, an Internet of Everything (IoE) device, a machine type communication (MTC) device, an appliance, an automobile, or the like.

The communication links 125 shown in wireless communication system 100 may include uplink channels from a UE 115 to a base station 105, and/or downlink channels, from a base station 105 to a UE 115. The downlink channels may also be called forward link channels, while the uplink channels may also be called reverse link channels. Control information and data may be multiplexed on an uplink channel or downlink according to various techniques. Control information and data may be multiplexed on a downlink channel, for example, using time-division multiplexing (TDM) techniques, frequency-division multiplexing (FDM) techniques, or hybrid TDM-FDM techniques. In some examples, the control information transmitted during a TTI of a downlink channel may be distributed between different control regions in a cascaded manner (e.g., between a common control region and one or more UE-specific control regions).

One or more of base stations 105 may include a network communication manager 101, which may identify a first modulation scheme (e.g., 16 QAM) having a first constellation for a first subset of DL transmissions (e.g., data payload transmissions in data symbols) in a TTI. The network communication manager 101 additionally or alternatively may identify a second modulation scheme (e.g., QPSK) having a second constellation for a second subset of DL transmissions (e.g., reference signal, embedded control, tapered payload transmissions in one or more symbols) in the TTI, the second constellation having fewer constellation points than the first constellation. A subset of constellation points of the first constellation may be selected for transmitting the second subset of DL transmissions, such that the subset of constellation points corresponds to one or more constellation points of the first modulation scheme and have an average power that is the same or similar to an average constellation point power of the first constellation. The first subset of DL transmissions using the first modulation scheme and the second subset of DL transmissions using the selected subset of constellation points of the first constellation may then be transmitted. A receiver, such as a UE 115 that receives the DL transmissions may perform interference mitigation that may reduce or eliminate interference from concurrent transmissions from other UEs 115 or base stations 105 that may be transmitted using such techniques.

UEs 115 may include a UE communication manager 102, which, similarly as discussed with respect to DL transmissions from a base station 105, may identify a first modulation scheme (e.g., 16 QAM) having a first constellation for a first subset of UL transmissions (e.g., data payload transmissions in data symbols) in a TTI. The UE communication manager 102 may additionally or alternatively identify a second modulation scheme (e.g., QPSK) having a second constellation for a second subset of UL transmissions (e.g., reference signal, embedded control, tapered payload transmissions in one or more symbols) in the TTI, the second constellation having fewer constellation points than the first constellation. A subset of constellation points of the first constellation may be selected for transmitting the second subset of UL transmissions, such that the subset of constellation points corresponds to one or more constellation points of the first modulation scheme and have an average power that is the same or similar to an average constellation point power of the first constellation. The first subset of UL transmissions using the first modulation scheme and the second subset of UL transmissions using the selected subset of constellation points of the first constellation may then be transmitted. A receiver, such as a base station 105 or another UE 115 that receives the UL transmissions may perform interference mitigation that may reduce or eliminate interference from concurrent transmissions that may be transmitted using such techniques.

Wireless communication system 100 may support operation on multiple cells or carriers, a feature which may be referred to as carrier aggregation (CA) or multi-carrier operation. A carrier may also be referred to as a component carrier (CC), a layer, a channel, etc. The terms “carrier,” “component carrier,” “cell,” and “channel” may be used interchangeably herein. A UE 115 may be configured with multiple downlink CCs and one or more uplink CCs for carrier aggregation. Carrier aggregation may be used with both frequency division duplex (FDD) and time division duplex (TDD) component carriers.

In some cases, wireless communications system 100 may utilize enhanced component carriers (eCCs). An eCC may be characterized by one or more features including: wider bandwidth, shorter symbol duration, and shorter TTIs. In some cases, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (where more than one operator is allowed to use the spectrum).

In some cases, an eCC may utilize a different symbol duration than other CCs, which may include use of a reduced symbol duration as compared with symbol durations of the other CCs. A shorter symbol duration is associated with increased subcarrier spacing. A device, such as a UE 115 or base station 105, utilizing eCCs may transmit wideband signals (e.g., 20, 40, 60, 80 Mhz, etc.) at reduced symbol durations (e.g., 16.67 microseconds). A TTI in eCC may comprise of one or multiple symbols. In some cases, the TTI duration (that is, the number of symbols in a TTI) may be variable. A 5G NR carrier may be considered an eCC.

Wireless communication system 100 may operate in an ultra-high frequency (UHF) frequency region using frequency bands from 700 MHz to 2600 MHz (2.6 GHz), although in some cases wireless local area network (WLAN) networks may use frequencies as high as 4 GHz. This region may also be known as the decimeter band, since the wavelengths range from approximately one decimeter to one meter in length. UHF waves may propagate mainly by line of sight, and may be blocked by buildings and environmental features. However, the waves may penetrate walls sufficiently to provide service to UEs 115 located indoors. Transmission of UHF waves is characterized by smaller antennas and shorter range (e.g., less than 100 km) compared to transmission using the smaller frequencies (and longer waves) of the high frequency (HF) or very high frequency (VHF) portion of the spectrum. In some cases, wireless communication system 100 may also utilize extremely high frequency (EHF) portions of the spectrum (e.g., from 30 GHz to 300 GHz). This region may also be known as the millimeter band, since the wavelengths range from approximately one millimeter to one centimeter in length, and systems that use this region may be referred to as millimeter wave (mmW) systems. Thus, EHF antennas may be even smaller and more closely spaced than UHF antennas. In some cases, this may facilitate use of antenna arrays within a UE 115 (e.g., for directional beamforming). However, EHF transmissions may be subject to even greater atmospheric attenuation and shorter range than UHF transmissions. Techniques disclosed herein may be employed across transmissions that use one or more different frequency regions.

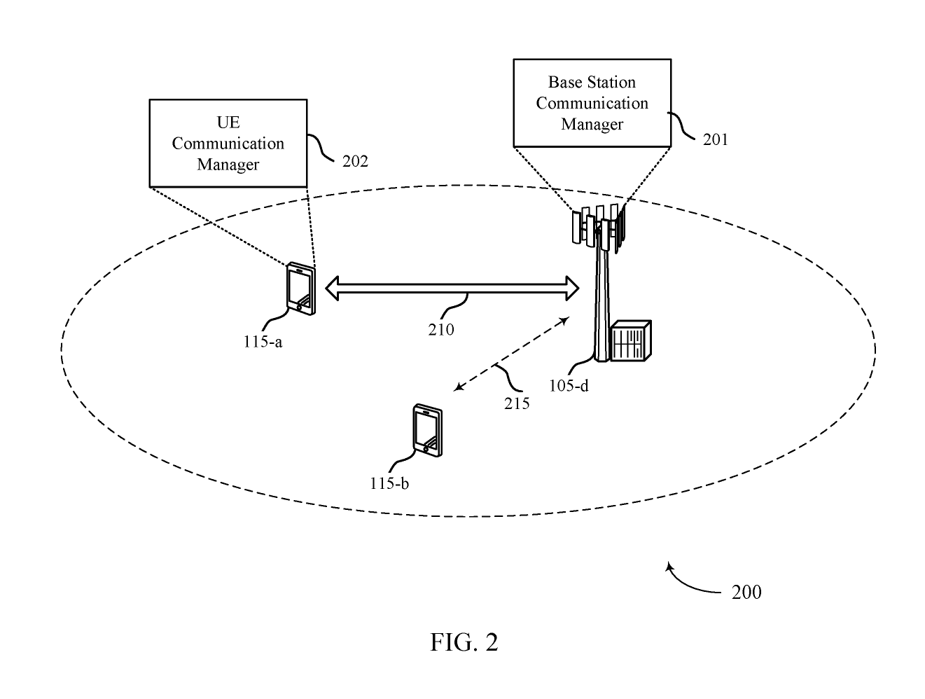

FIG. 2 illustrates an example of a wireless communications system 200 that may use nested constellation techniques for payload-tapering, embedded control, or reference signal transmissions in accordance with one or more aspects of the present disclosure. Wireless communications system 200 may include base station 105-d, a first UE 115-a, and a second UE 115-b, which may be examples of the corresponding devices described with reference to FIG. 1. Wireless communications system 200 may use a communications configuration that includes uplink-centric subframes and downlink-centric subframes that may provide self-contained subframes, although techniques described herein may be used in other types of systems as well.

In some examples, the base station 105-d may include a base station communication manager 201, which may be an example of network communication manager 101 of FIG. 1, and may be used to identify a first modulation scheme (e.g., 16 QAM) having a first constellation for a first subset of DL transmissions (e.g., data payload transmissions in data symbols) in a TTI or a slot, that may be transmitted using communication link 210. The base station communication manager 201 also may identify a second modulation scheme (e.g., QPSK) having a second constellation for a second subset of DL transmissions (e.g., reference signal, embedded control, tapered payload transmissions in one or more symbols) in the TTI, the second constellation having fewer constellation points than the first constellation. A subset of constellation points of the first constellation may be selected for transmitting the second subset of DL transmissions, such that the subset of constellation points corresponds to one or more constellation points of the first modulation scheme and have an average power that is the same or similar to an average constellation point power of the first constellation. The first subset of DL transmissions using the first modulation scheme and the second subset of DL transmissions using the selected subset of constellation points of the first constellation may then be transmitted.

A receiver, such as a UE 115-a that receives the DL transmissions may perform interference mitigation that may reduce or eliminate interference that may be received from concurrent transmissions 215 between second UE 115-b and base station 105-d. For example, second UE 115-b and base station 105-d may transmit subframes that are synchronized with subframes transmitted between the first UE 115-a and the base station 105-d, and that use nested constellations. The concurrent transmissions 215 may cause interference at the first UE 115-a. However, because the concurrent transmissions 215 may have a relatively constant power level, and use the same of similar constellation points, across all of the transmitted symbols, the first UE 115-a may be able to fully implement interference cancellation and/or interference suppression, and reduce the likelihood that the interference from the concurrent transmissions 215 may cause an unsuccessful reception of the DL transmissions in communications link 210, which can help to increase the overall efficiency and data throughput of the wireless communication system 200.

The UE 115-a may include a UE communication manager 202, which may be an example of UE communication manager 102 of FIG. 1, and may be used to perform similar functions as discussed with respect to base station communication manager 201 for UL transmissions.

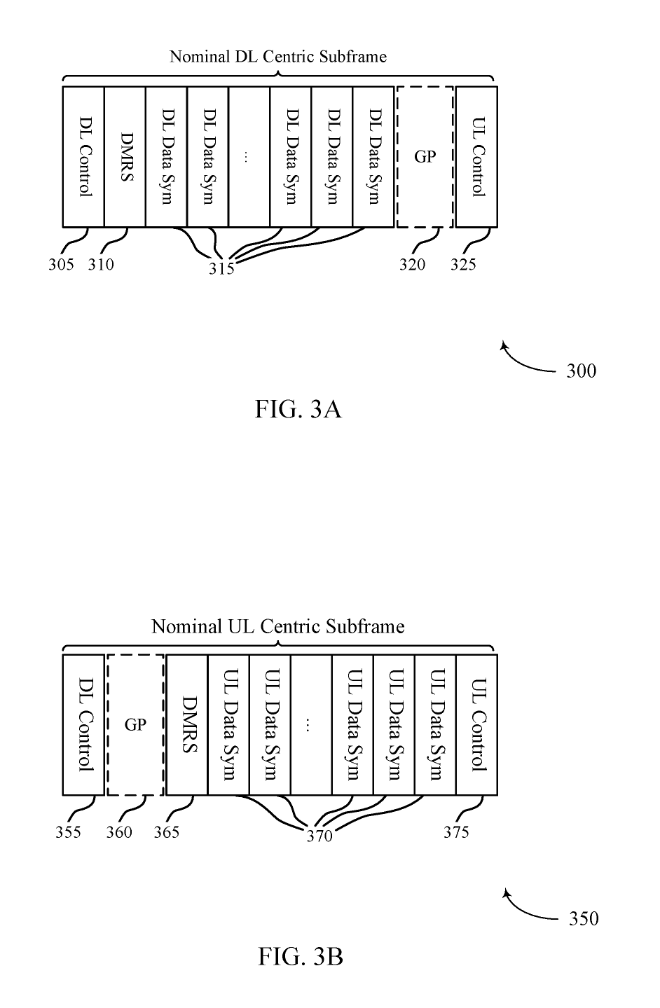

FIG. 3A illustrates an example of a downlink-centric subframe 300, and FIG. 3B illustrates an example of an uplink-centric subframe 350, that support nested constellation techniques for payload-tapering, embedded control, or reference signal transmissions in accordance with one or more aspects of the present disclosure. In some examples, the DL-centric subframe 300 may be selected by a network access device such as a base station 105 of FIGS. 1-2, based at least in part on a UL/DL traffic ratio. For example, a base station may select a DL-centric dynamic subframe type for the subframe 300 when the UL/DL traffic ratio that indicates more traffic is queued by the base station for transmission to one or more UEs than is queued by the one or more UEs for transmission to the base station. In some examples, the base stations and UEs that communicate in the subframe 300 may be examples of aspects of the base stations 105 and UEs 115 described with reference to FIGS. 1-2. While various examples described herein use downlink-centric or uplink-centric subframes, it will be understood that the techniques described are equally applicable to other types of subframes, such as pure downlink or uplink subframes.

The DL-centric subframe 300 may begin with a DL control symbol 305, that may include, for example, a cell-specific reference signal (CRS) and physical downlink control channel (PDCCH) transmissions. Following the DL control symbol 305, a DL demodulation reference signal (DMRS) symbol 310 may be transmitted, followed by a number of DL data symbols 315 which may include physical downlink shared channel (PDSCH) transmissions. Following the DL data symbols 315, a guard period 320 may be provided to allow the UE to perform radio frequency (RF) switching from downlink receptions to uplink transmissions. Following the guard period 320, a UL control symbol 325 may be scheduled for transmission by the UE of information such as a sounding reference signal (SRS), scheduling request (SR), feedback (e.g., ACK/NACK information), or UL data. Such a UL control symbol 325 may allow for a self-contained subframe 300, in which feedback on successful reception of data in the data region 315 may be provided within the same subframe, which may provide for lower latency and enhanced data throughput relative to providing feedback information in some number of subframes after the DL data symbols 315.

The UL-centric subframe 350 may begin with a DL control symbol 355 that may include CRS and PDCCH transmissions. The PDCCH transmissions may include, for example, an uplink allocation for uplink transmissions. Following the initial DL control symbol 355, a guard period 360 may be provided to allow the UE to perform RF switching from downlink receptions to uplink transmissions. Following the guard period 360, a UL DMRS symbol 365 may include UL DMRS transmissions, followed by a number of UL data symbols 370, which may include physical uplink shared channel (PUSCH) transmissions. Following the UL data symbols 315, an uplink control symbol 375 may include information such as an SRS, SR, feedback (e.g., ACK/NACK information), or uplink data.

As discussed above, in some cases the DL data symbols 315 and UL data symbols 370 may be transmitted using, for example, 16 QAM or 64 QAM. The DL control symbols 305 and DL control symbols 355, DL DMRS symbols 310, UL DMRS symbols 365, and UL control symbols 325 and UL control symbols 375 may be transmitted using, for example, QPSK modulation.

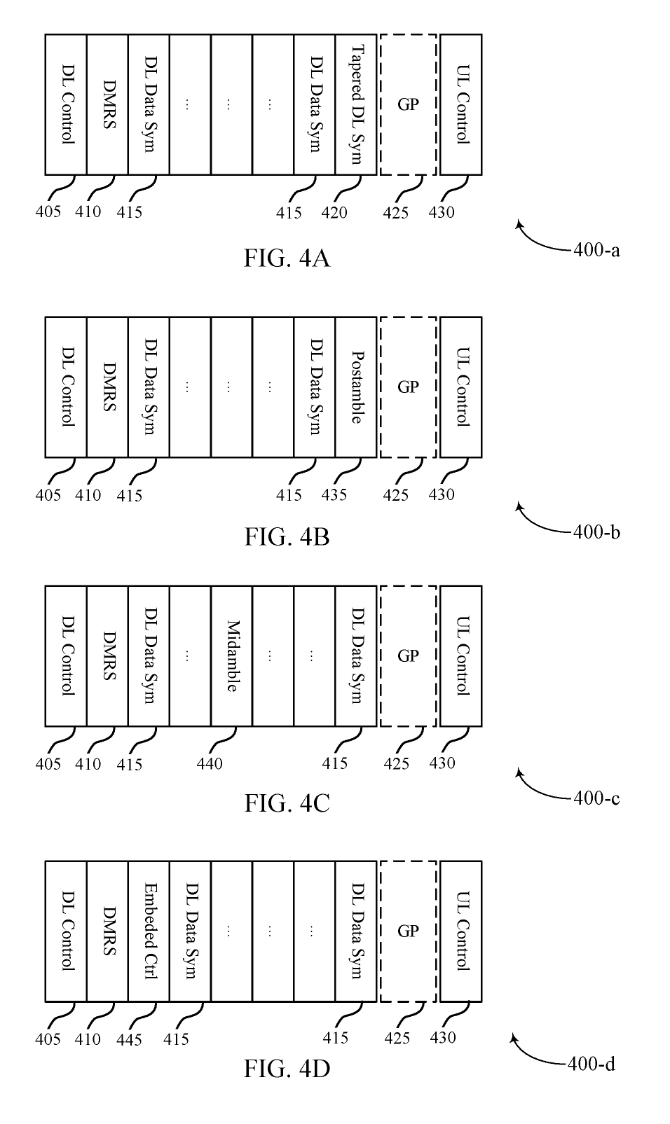

FIGS. 4A through 4D illustrate examples of downlink-centric subframes that include payload-tapered symbols, embedded control symbols, or reference signal symbols in accordance with one or more aspects of the present disclosure. The DL-centric subframes of FIGS. 4A-4D may be used for communications between base stations and UEs such as discussed with reference to FIGS. 1-2. In the example of FIG. 4A, a DL control symbol 405 may transmitted, using QPSK modulation, followed by a DMRS symbol 410 transmitted using QPSK. One or more data symbols 415 may be transmitted using, for example, 64 QAM. In this example, a tapered DL symbol 420 is the last DL symbol transmitted, followed by a guard period 425 and an uplink control symbol 430. The tapered DL symbol 420 may include fewer data payload bits than other DL data symbols 415 and may be carried toward the end of the DL centric-subframe 400-a DL transmissions to improve UE processing timelines in the case of, for example, a single HARQ process where the UE needs to provide ACK/NACK feedback in the UL control symbol 430. In some examples, such a tapered DL symbol 420 may be transmitted using 16 QAM or QPSK.

In the example of FIG. 4B, a DL-centric subframe 400-b may include DL control symbol 405, DMRS symbol 410, DL data symbols 415, a guard period 425, and a UL control symbol 430 similarly as discussed with respect to FIG. 4A. The example of FIG. 4B also includes a postamble symbol 435. Such a postamble symbol 435 may include DL data and reference signals that may help the channel estimation performance (e.g., non-causal processing) by allowing interpolation of interference levels between the DMRS symbol 410 and the postamble symbol 435. Such a postamble symbol 435 may be transmitted using QPSK modulation.

In the example of FIG. 4C, a DL-centric subframe 400-c may include DL control symbol 405, DMRS symbol 410, DL data symbols 415, a guard period 425, and a UL control symbol 430 similarly as discussed with respect to FIGS. 4A and 4B. The example of FIG. 4C also includes a midamble symbol 440. Such a midamble symbol 440 may, similar to the postamble symbol 435, include DL data and reference signals that may help the channel estimation performance (e.g., non-causal processing) by allowing interpolation of interference levels between the DMRS symbol 410 and the midamble symbol 440. Such a midamble symbol 440 may be transmitted using QPSK modulation.

In the example of FIG. 4D, a DL-centric subframe 400-d may include DL control symbol 405, DMRS symbol 410, DL data symbols 415, a guard period 425, and a UL control symbol 430 similarly as discussed with respect to FIGS. 4A through 4C. The example of FIG. 4D also includes an embedded control symbol 445. Such an embedded control symbol 445 may provide additional control information to a UE, and may be transmitted using QPSK modulation. Additionally, various DL-centric subframes may include any combination of the various different types of symbols described with reference to FIGS. 4A through 4D.

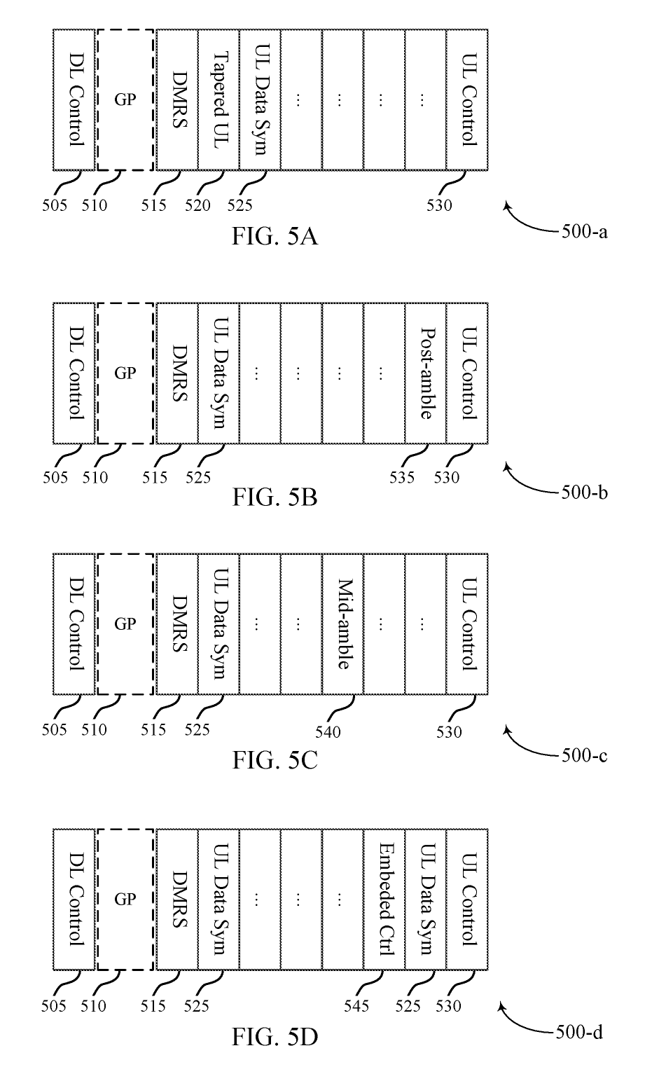

FIGS. 5A through 5D illustrate examples of UL-centric subframes that include payload-tapered symbols, embedded control symbols, or reference signal symbols in accordance with one or more aspects of the present disclosure. The UL-centric subframes of FIGS. 5A-5D may be used for communications between base stations and UEs such as discussed with reference to FIGS. 1-2. In the example of FIG. 5A, a DL control symbol 505 may transmitted, using QPSK modulation, followed by guard period 510, and an UL DMRS symbol 515 transmitted using QPSK. A tapered UL symbol 520 may then be transmitted, using QPSK modulation, followed by one or more UL data symbols 525 that may be transmitted using, for example, 16 QAM or 64 QAM. In this example, the tapered UL symbol 520 is the first UL data symbol transmitted, followed by a guard period 510, and may include fewer data payload bits than other UL data symbols 525 to improve UE or base station processing timelines. In some examples, such a tapered UL symbol 520 may be transmitted using 16 QAM or QPSK.

In the example of FIG. 5B, a UL-centric subframe 500-b may include DL control symbol 505, guard period 510, DMRS symbol 515, UL data symbols 525, and a UL control symbol 530 similarly as discussed with respect to FIG. 5A. The example of FIG. 5B also includes a postamble symbol 535. Such a postamble symbol 535 may include UL data and reference signals that may help the channel estimation performance (e.g., non-causal processing) by allowing interpolation of interference levels between the DMRS symbol 515 and the postamble symbol 535. Such a postamble symbol 535 may be transmitted using QPSK modulation.

In the example of FIG. 5C, a UL-centric subframe 500-c may include DL control symbol 505, guard period 510, DMRS symbol 515, UL data symbols 525, and a UL control symbol 530 similarly as discussed with respect to FIGS. 5A and 5B. The example of FIG. 5C also includes a midamble symbol 540. Such a midamble symbol 540 may, similar to the postamble symbol 535, include UL data and reference signals that may help the channel estimation performance (e.g., non-causal processing) by allowing interpolation of interference levels between the DMRS symbol 515 and the midamble symbol 540. Such a midamble symbol 540 may be transmitted using QPSK modulation.

In the example of FIG. 5D, a UL-centric subframe 500-d may include DL control symbol 505, guard period 510, DMRS symbol 515, UL data symbols 525, and a UL control symbol 530 similarly as discussed with respect to FIGS. 5A through 5C. The example of FIG. 5D also includes an embedded control symbol 545. Such an embedded control symbol 545 may provide additional control information to the base station, and may be transmitted using QPSK modulation. Additionally, various UL-centric subframes may include any combination of the various different types of symbols described with reference to FIGS. 5A through 5D.

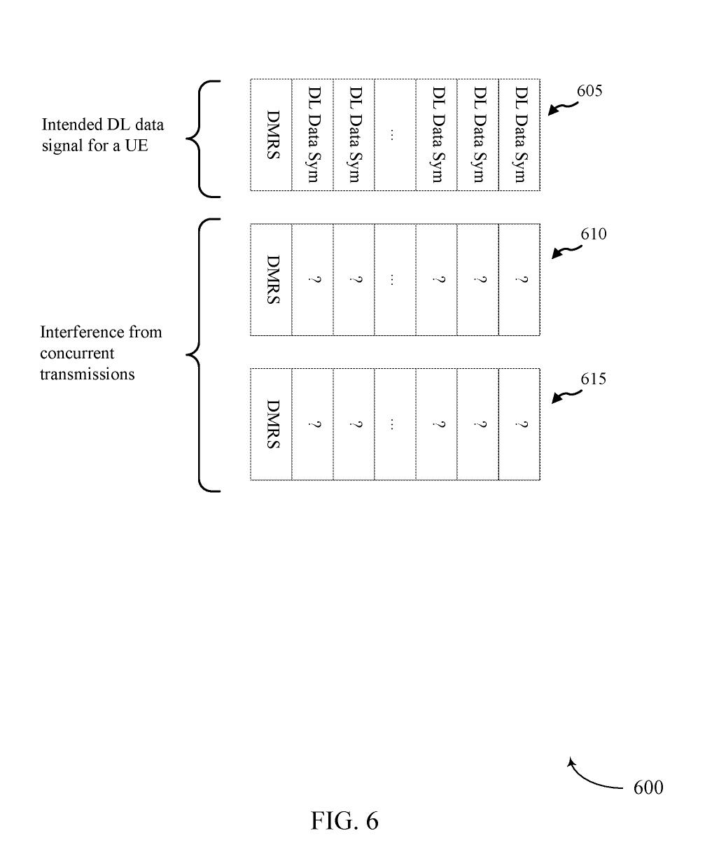

FIG. 6 illustrates an example 600 of a DL subframe and interfering concurrent other DL subframes in accordance with one or more aspects of the present disclosure. A DL subframe 600 of FIG. 6 may be used for communications between base stations and UEs such as discussed with reference to FIGS. 1-2, and may contain intended DL data signals for a UE. Concurrent with the DL subframe 605, other UL or DL subframes 610 and UL or DL subframes 615 may be transmitted.

As indicated above, in the event that interfering subframe 610 and interfering subframe 615 have various different configurations, such as different constellations and different power, the UE receiving the DL subframe 605 may have less success using interference mitigation techniques, which may result in an unsuccessful reception of some or all of the data transmitted in the DL subframe 605. Furthermore, if power and/or constellation type vary from symbol-to-symbol within the interfering subframes 610 and interfering subframes 615, an interference mitigation technique that is established based on a reference signal contained in the first symbol of each interfering symbol of interfering subframe 610 and interfering subframe 615 may be less effective or ineffective for a subsequent symbol that has a different power, different constellation, or both. In some examples, the interfering subframe 610 may be transmitted by a different transmitter transmitting within a same cell, such as a signal from another UE within a MU-MIMO transmission, for example. In some examples, the interfering subframe 615 may be transmitted by a transmitter in a different cell, such as a signal from a UE in a neighboring cell, for example. In some examples, each of the subframes 605 through 615 may be transmitted using the same or similar constellations, with a same or similar average power, between symbols and across devices, and thereby allow for enhanced mitigation techniques to be employed when multiple transmitters have concurrent transmissions.

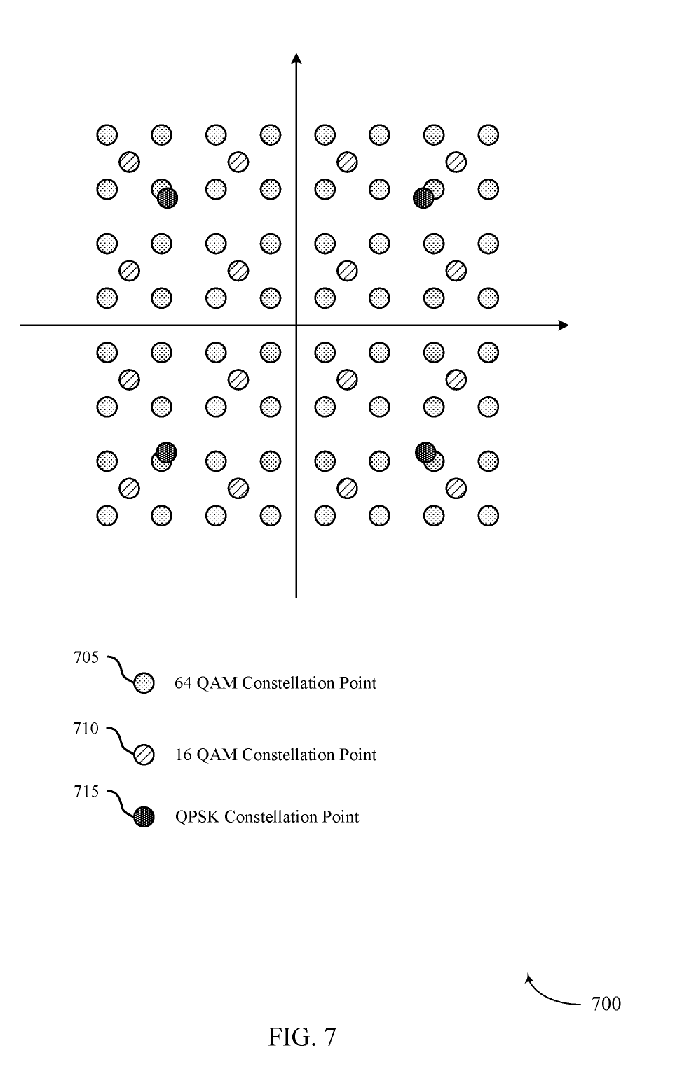

FIG. 7 illustrates an example of different modulation constellations 700 that support nested constellation techniques for payload-tapering, embedded control, or reference signal transmissions in accordance with one or more aspects of the present disclosure. In this example, constellation points of different modulation orders are overlayed to illustrate how different constellation points align. In this example, 64 QAM constellation points 705, 16 QAM constellation points 710, and QPSK constellation points 715 are illustrated. As can be observed, the 16 QAM constellation points 710 do not overlay closely with any 64 QAM constellation points 705 or QPSK constellation points 715. Thus, if a receiver is using an interference mitigation technique that is based on an interfering transmission having a 64 QAM constellation, the interference mitigation technique may be ineffective. As can also be observed, the QPSK constellation points 715 align somewhat closely to some of the 64 QAM constellation points 705. However, if such a QPSK transmission uses a substantially different power than an average 64 QAM constellation point power, interference mitigation at a receiver may be impacted. Thus, with normalized power, a larger constellation normally does not have smaller constellation as a subset. Various examples provided herein provide for having a smaller constellation as a subset of a larger constellation.

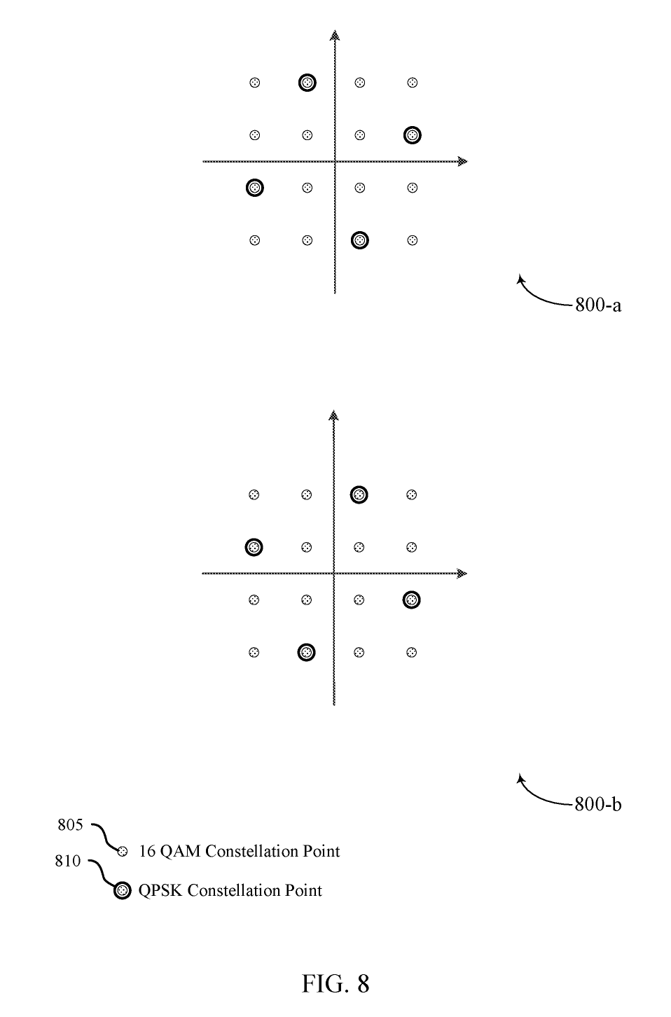

FIG. 8 illustrates an example of a 16 QAM constellation 800 that supports nested constellation techniques for payload-tapering, embedded control, or reference signal transmissions in accordance with one or more aspects of the present disclosure. In this example, the 16 QAM constellation points 805 include a subset of constellation points that may be used as QPSK constellation points 810. The subset of constellation points selected as the subset of constellation points may be selected such that they have a same (or similar) average power, and used as the QPSK constellation points 810, which can be used, for example, for reference signal, embedded control, or tapered-payload transmissions. In the 16 QAM constellation 800-a, a certain subset of constellation can be used as phase-rotated QPSK constellation points 810. Similarly, in the 16 QAM constellation 800-b, a different subset of constellation may be used as phase-rotated QPSK constellation points 810. In either case, the selected subset of constellation points may be selected to have the same average power as the 16 QAM constellation. The average power may be identified, for example, as the sum of the squared distances of a constellation point from the origin of the constellation. Thus, for QPSK transmitted using a subset of 16 QAM, the selected subset of constellation points may have the same average power as the 16 QAM constellation.

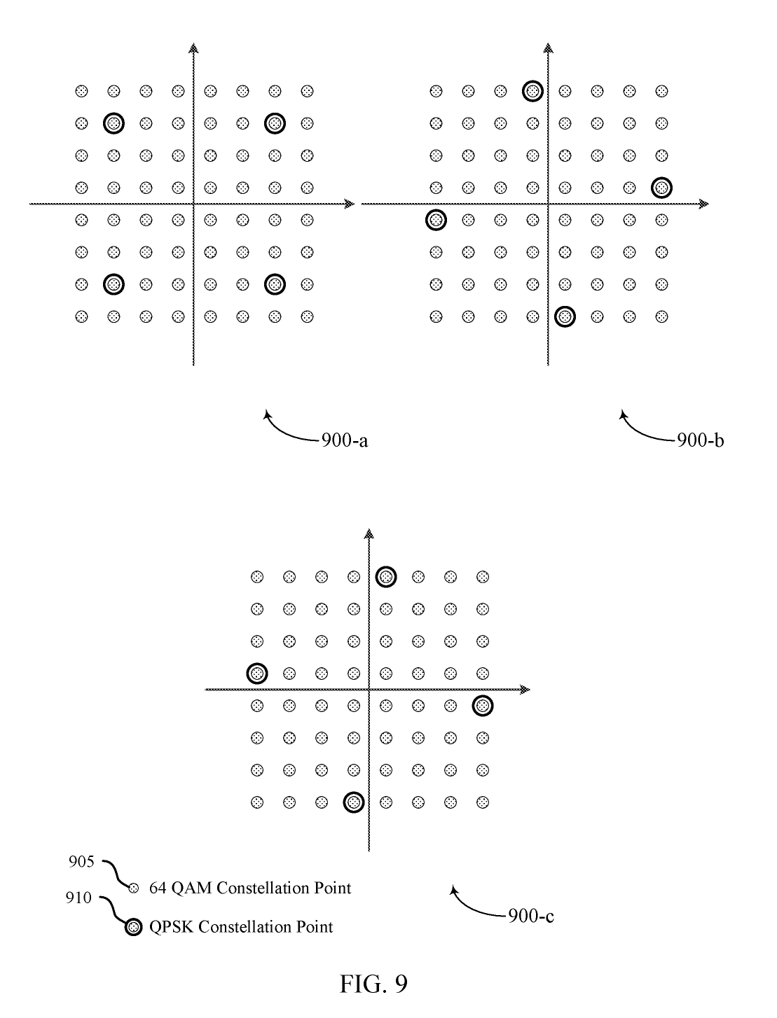

FIG. 9 illustrates an example of a 64 QAM constellation 900 that supports nested constellation techniques for payload-tapering, embedded control, or reference signal transmissions in accordance with one or more aspects of the present disclosure. In this example, the 64 QAM constellation points 905 include a subset of constellation points that may be used as QPSK constellation points 910. The subset of constellation points selected as the subset of constellation points may be selected such that they have a similar average power, and may be used as the QPSK constellation points 910, which can be used, for example, for reference signal, embedded control, or tapered-payload transmissions. In the 64 QAM constellation 900-a, a certain subset of constellation can be used as non-phase-rotated QPSK constellation points 910, that have a similar location as a QPSK constellation.

In the 64 QAM constellation 900-b, a different subset of 64 QAM constellation points 905 may be used as phase-rotated QPSK constellation points 910. Similarly, in the 64 QAM constellation 900-c, a different subset of constellation may be used as phase-rotated QPSK constellation points 910. In the examples of 64 QAM constellations 900-b and 64 QAM constellations 900-c, the selected subset of constellation points may be selected to have a similar average power as the 64 QAM constellation. Such a similar average power may provide a relatively small impact on interference mitigation techniques of a receiver that may receive transmissions using the subset of constellation points as QPSK constellation points 910 as interfering transmissions.

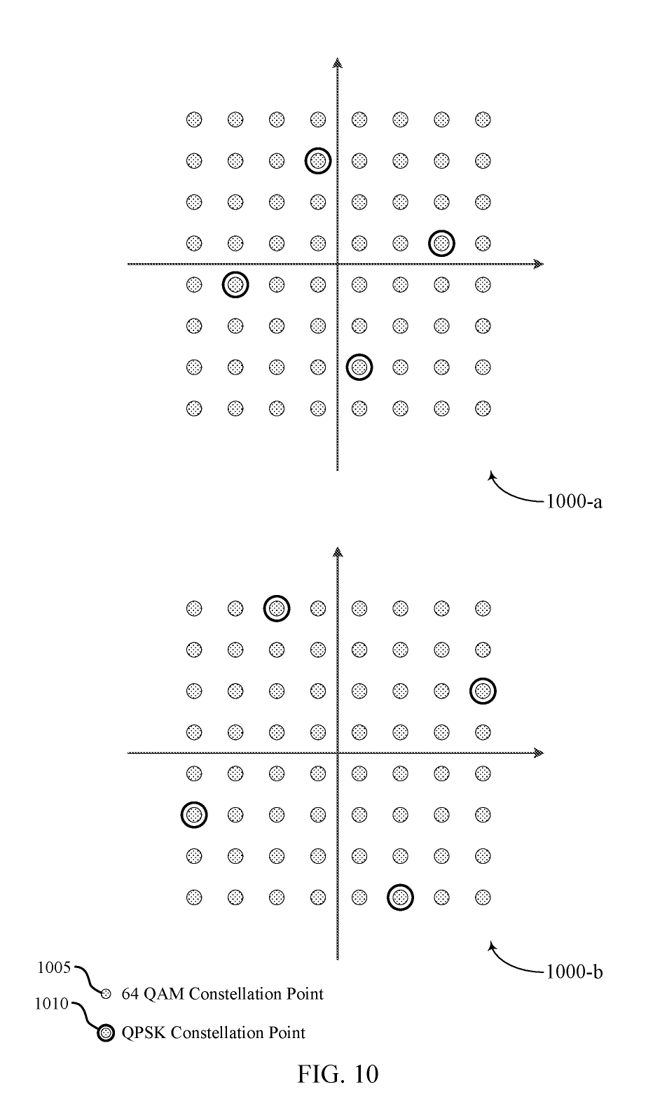

FIG. 10 illustrates another example of a 64 QAM constellation 1000 that supports nested constellation techniques for payload-tapering, embedded control, or reference signal transmissions in accordance with one or more aspects of the present disclosure. In this example, the 64 QAM constellation 1000-a may include 64 QAM constellation points 1005 having a first subset of constellation points that may be used as QPSK constellation points 1010 for a first portion of QPSK transmissions. The 64 QAM constellation 1000-b may include 64 QAM constellation points 1005 having a second subset of constellation points that may be used as QPSK constellation points 1010 for a second portion of QPSK transmissions. The first and second subsets of constellation points may be selected such that they have a same average power, and may be used as the QPSK constellation points 1010, which can be used, for example, for reference signal, embedded control, or tapered-payload transmissions. The different subsets of constellation points may be transmitted in an alternating pattern, such as in alternating frequency tones, to achieve a same or similar power as the original 64 QAM constellation. While the examples of FIGS. 7-10 illustrate several exemplary modulation orders, other modulation orders may be provided in a similar manner.

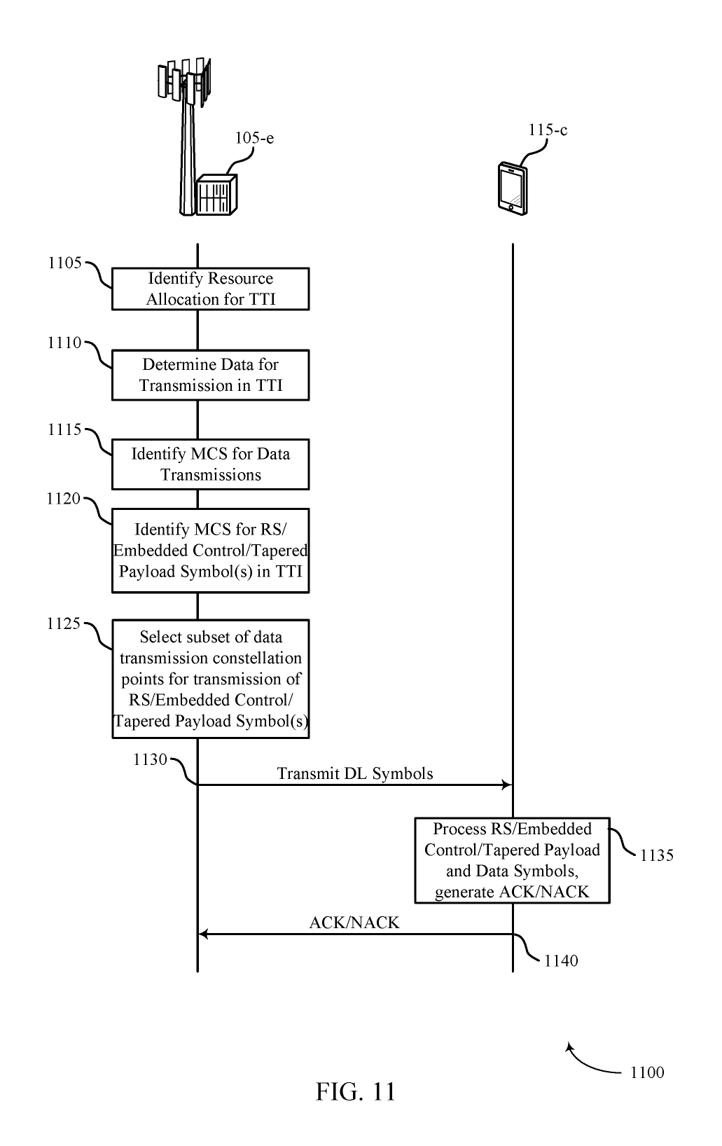

FIG. 11 illustrates an example of a process flow 1100 that supports nested constellation techniques for payload-tapering, embedded control, or reference signal transmissions in accordance with one or more aspects of the present disclosure. Process flow 1100 may include base station 105-e and UE 115-c, which may be examples of the corresponding devices described with reference to FIGS. 1-2. The base station 105-e, at block 1105, may identify a resource allocation for a TTI. This identification may be performed as part or pre-processing prior to a DL transmission. The base station 105-e determine data for transmission in the TTI, as indicated at block 1110. At block 1115, the base station 105-e may identify a modulation and coding scheme (MCS) for the data transmissions. As discussed above, such a MCS may include a modulation scheme (e.g., a 16 QAM or 64 QAM modulation scheme) for DL data transmissions. In some examples, the identification of the MCS may additionally or alternatively include identification of a second MCS for tapered data transmissions, which may have a smaller amount of data and may use a smaller modulation order.

At block 1120, the base station 105-e may identify a MCS for reference signal, embedded control, and tapered payload symbol(s). As discussed above, such an MCS for these symbols may have a lower modulation order than a modulation order for non-tapered data symbols. At block 1125, the base station 150-e may select a subset of data transmission constellation points from a constellation for the non-tapered data symbols, for transmission of reference signal, embedded control, tapered payload symbol(s), or symbols having any combination thereof. The base station 105-e may transmit the DL symbols 1130, which may be received at the UE 115-c. The UE may, at block 1135, process the received DL symbols and generate an ACK/NACK feedback 1140 that may be transmitted back to the base station 105-e. In some examples, the processing at the UE 115-c may include interference mitigation techniques that may mitigate interference that may be present from one or more other interfering transmissions from one or more other base stations or UEs.

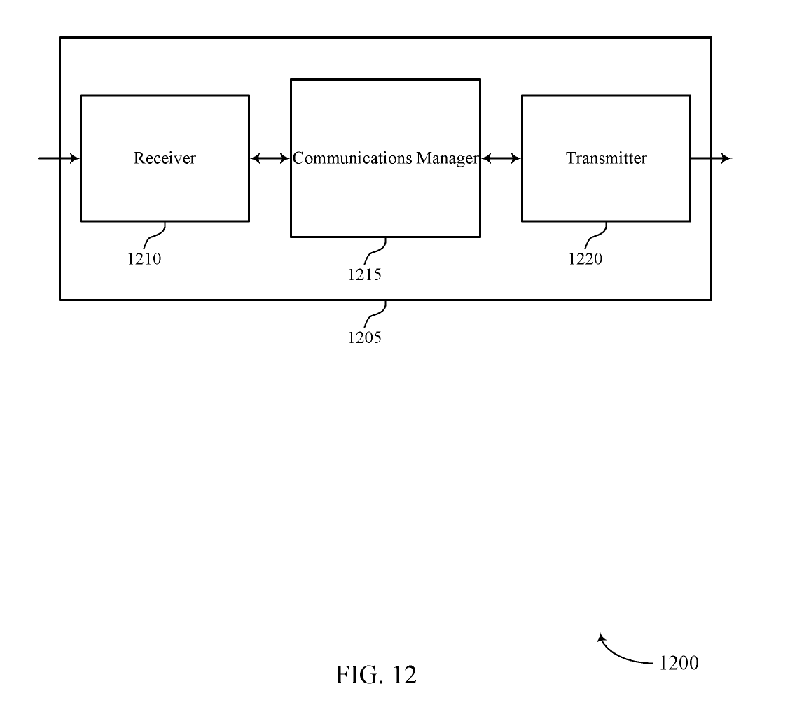

FIG. 12 shows a block diagram 1200 of a wireless device 1205 that supports nested constellation techniques for payload-tapering, embedded control, or reference signal transmissions in accordance with one or more aspects of the present disclosure. Wireless device 1205 may be an example of aspects of a UE 115 or base station 105 as described with reference to FIGS. 1-2. Wireless device 1205 may include receiver 1210, communications manager 1215, and transmitter 1220. Wireless device 1205 may also include a processor. Each of these components may be in communication with one another (e.g., via one or more buses).

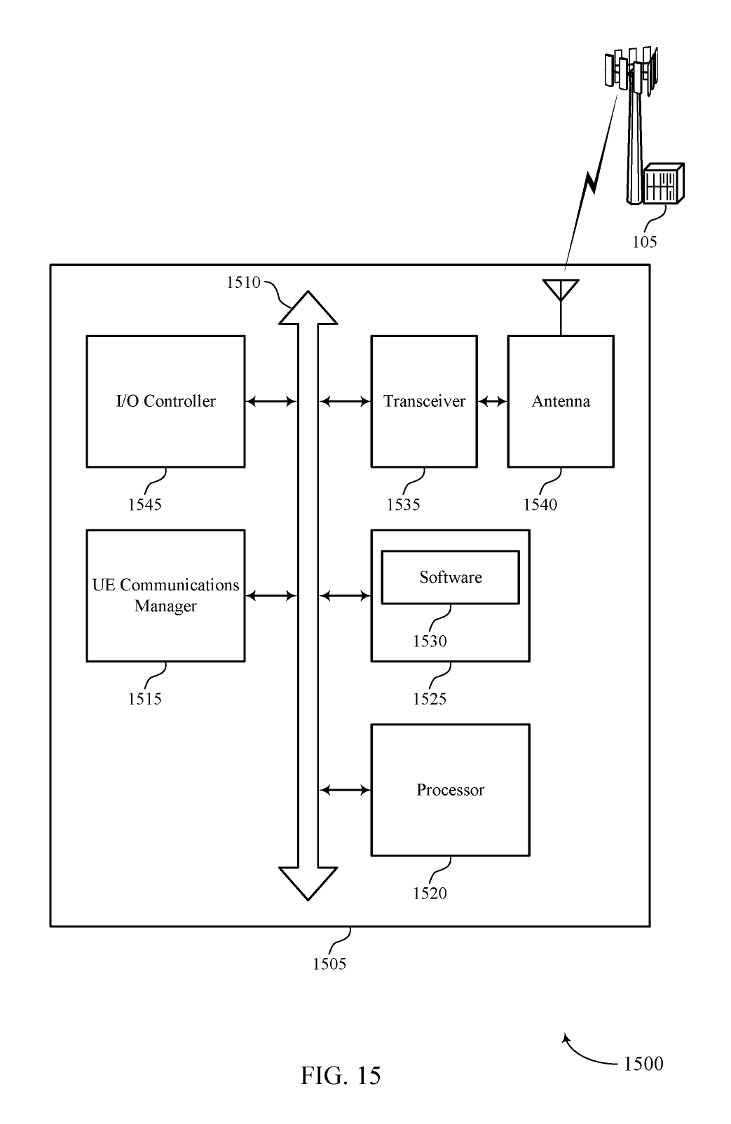

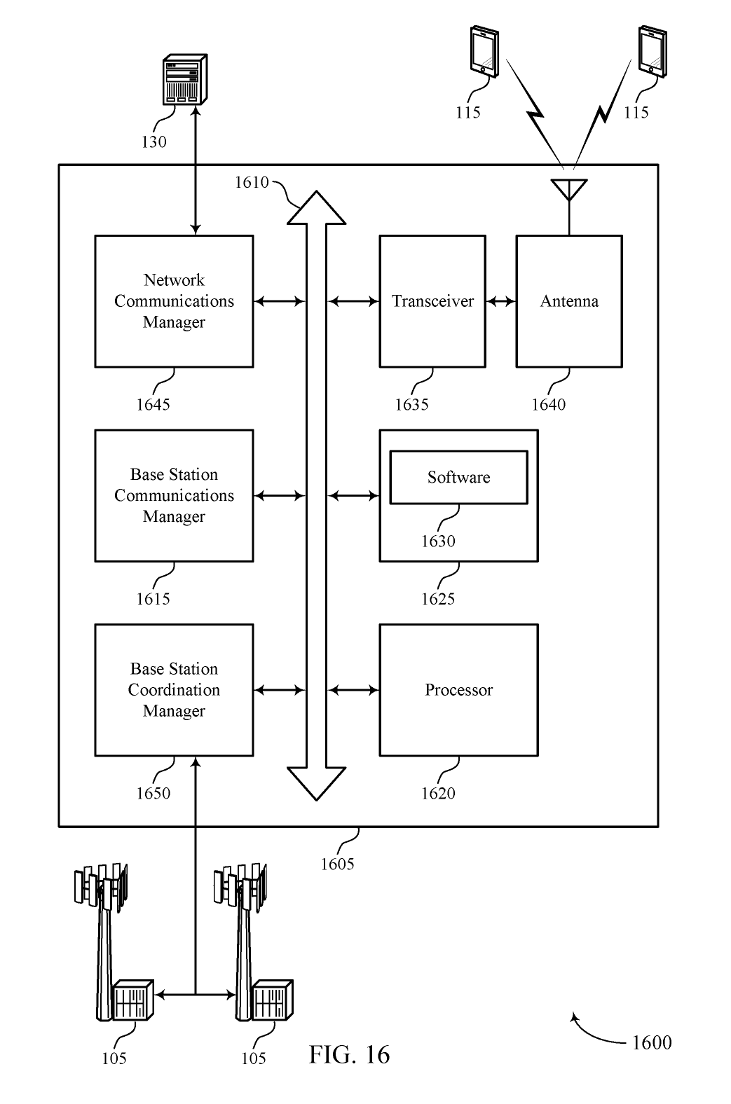

Receiver 1210 may receive information such as packets, user data, or control information associated with various information channels (e.g., control channels, data channels, and information related to nested constellation techniques for payload-tapering, embedded control, or reference signal transmissions, etc.). Information may be passed on to other components of the device. The receiver 1210 may be an example of aspects of the transceiver 1535 described with reference to FIG. 15 or transceiver 1635 described with reference to FIG. 16.

Communications manager 1215 may be an example of aspects of the UE communications manager 1515 described with reference to FIG. 15 or the base station communications manager 1615 described with reference to FIG. 16.

Communications manager 1215 may identify a first modulation scheme having a first constellation for a first subset of transmissions in a TTI, identify a second modulation scheme having a second constellation for a second subset of transmissions in the TTI, the second constellation having fewer constellation points than the first constellation, select a subset of constellation points of the first constellation for transmitting the second subset of transmissions, the subset of constellation points corresponding to one or more constellation points of the first modulation scheme and having an average power that is the same or similar to an average constellation point power of the first constellation, and transmit the first subset of transmissions using the first modulation scheme and the second subset of transmissions using the selected subset of constellation points of the first constellation.

Transmitter 1220 may transmit signals generated by other components of the device. In some examples, the transmitter 1220 may be collocated with a receiver 1210 in a transceiver module. For example, the transmitter 1220 may be an example of aspects of the transceiver 1535 described with reference to FIG. 15 or transceiver 1635 described with reference to FIG. 16. The transmitter 1220 may include a single antenna, or it may include a set of antennas.

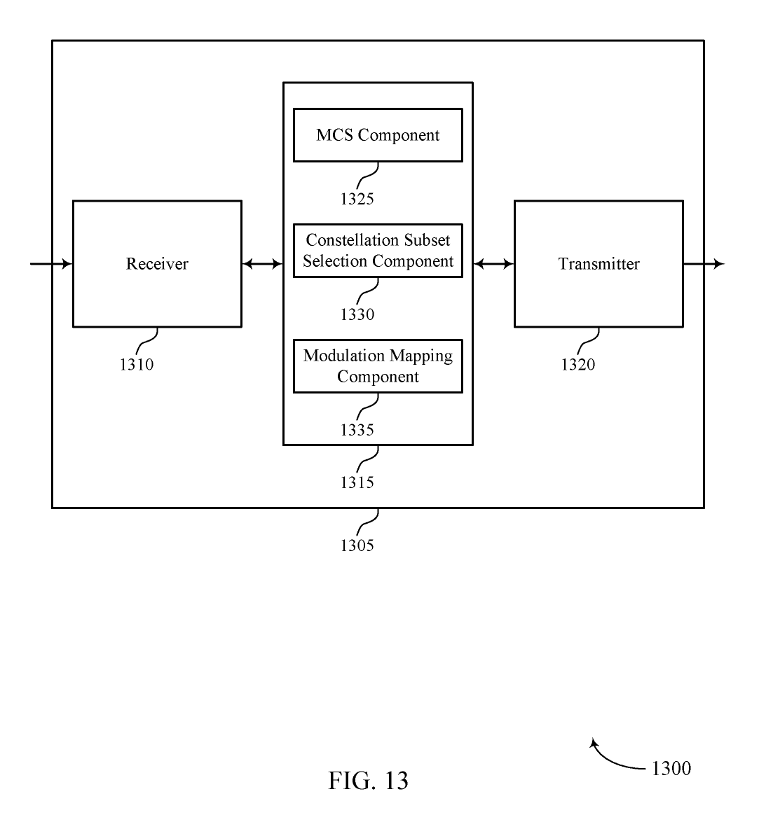

FIG. 13 shows a block diagram 1300 of a wireless device 1305 that supports nested constellation techniques for payload-tapering, embedded control, or reference signal transmissions in accordance with one or more aspects of the present disclosure. Wireless device 1305 may be an example of aspects of a wireless device 1205 or a UE 115 or base station 105 as described with reference to FIGS. 1, 2 and 12. Wireless device 1305 may include receiver 1310, communications manager 1315, and transmitter 1320. Wireless device 1305 may also include a processor. Each of these components may be in communication with one another (e.g., via one or more buses).

Receiver 1310 may receive information such as packets, user data, or control information associated with various information channels (e.g., control channels, data channels, and information related to nested constellation techniques for payload-tapering, embedded control, or reference signal transmissions, etc.). Information may be passed on to other components of the device. The receiver 1310 may be an example of aspects of the transceiver 1535 described with reference to FIG. 15 or transceiver 1635 described with reference to FIG. 16.

Communications manager 1315 may be an example of aspects of the communications manager 1515 described with reference to FIG. 15, or the base station communications manager 1615 described with reference to FIG. 16. Communications manager 1315 may also include MCS component 1325, constellation subset selection component 1330, and modulation mapping component 1335.

MCS component 1325 may identify a first modulation scheme having a first constellation for a first subset of transmissions in a TTI and identify a second modulation scheme having a second constellation for a second subset of transmissions in the TTI, the second constellation having fewer constellation points than the first constellation. In some cases, the identifying the first modulation scheme includes determining that the first subset of transmissions are to be transmitted using a 16 QAM or higher modulation scheme. In some cases, the identifying the second modulation scheme includes determining and the second subset of transmissions are to be transmitted using a QPSK modulation scheme.

In some cases, the first modulation scheme is a 64 QAM modulation scheme and the second modulation scheme is a QPSK modulation scheme, and the identifying constellation points of the 64 QAM modulation scheme includes identifying a first subset of constellation points of the 64 QAM modulation scheme and a second subset of constellation points of the 64 QAM modulation scheme that have a same average power as an average power of the first constellation. In some cases, the first modulation scheme is a 64 QAM modulation scheme and the second modulation scheme is a 16 QAM modulation scheme, and the selecting the subset of constellation points of the first constellation includes: identifying constellation points of the 64 QAM modulation scheme that have a power closest to an average power of the first constellation as the subset of constellation points of the first constellation.

Constellation subset selection component 1330 may select a subset of constellation points of the first constellation for transmitting the second subset of transmissions, the subset of constellation points corresponding to one or more constellation points of the first modulation scheme and having an average power that is the same or similar to an average constellation point power of the first constellation. In some cases, the subset of constellation points having an average power that is the same or similar to an average constellation point power of the first constellation provides for enhanced interference mitigation at a receiver relative to constellation points of the first constellation having a substantially different power than the average constellation point power of the first constellation. In some cases, the first subset of transmissions include data transmissions, and the second subset of transmissions include one or more of a reference signal transmission, a control signal transmission, a payload-tapered transmission, or any combination thereof. In some cases, the first modulation scheme is a 16 QAM modulation scheme, and the selecting the subset of constellation points of the first constellation includes: identifying constellation points of the 16 QAM modulation scheme that have a same power as an average power of the first constellation as the subset of constellation points of the first constellation. In some cases, the first modulation scheme is a 64 QAM modulation scheme, and the selecting the subset of constellation points of the first constellation includes: identifying constellation points of the 64 QAM modulation scheme that have a power closest to an average power of the first constellation as the subset of constellation points of the first constellation.

Modulation mapping component 1335 may, in some examples, coordinate alternating subsets of a first modulation scheme for the second subset of transmissions that may combine to have an average power that is the same or similar as the average power of the first modulation scheme. In some cases, a first portion of the second subset of transmissions and a second portion of the second subset of transmissions are transmitted using alternating frequency tones of the second subset of transmissions.

Transmitter 1320 may transmit signals generated by other components of the device. In some examples, the transmitter 1320 may be collocated with a receiver 1310 in a transceiver module. For example, the transmitter 1320 may be an example of aspects of the transceiver 1535 described with reference to FIG. 15 or transceiver 1635 described with reference to FIG. 16. The transmitter 1320 may include a single antenna, or it may include a set of antennas.

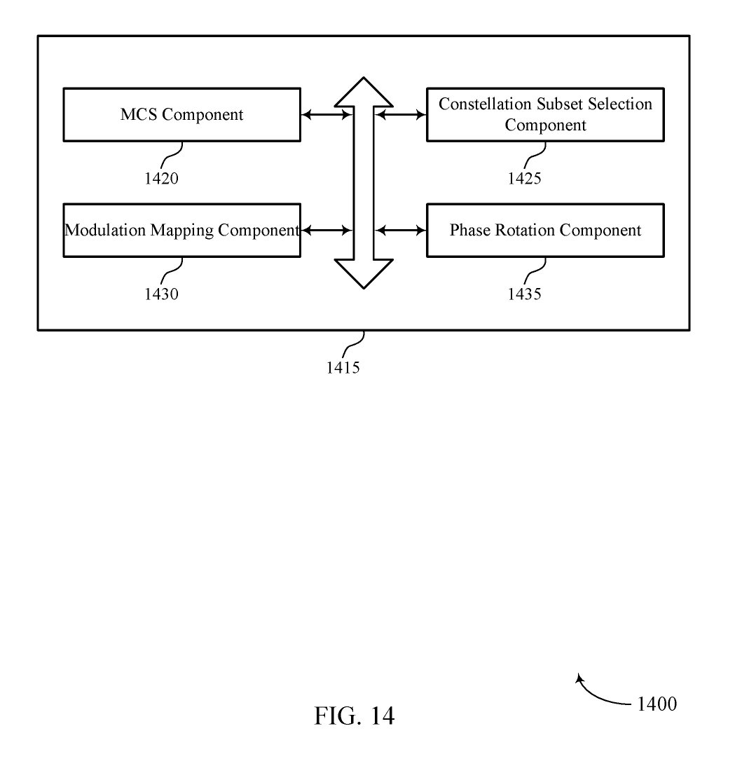

FIG. 14 shows a block diagram 1400 of a communications manager 1415 that supports nested constellation techniques for payload-tapering, embedded control, or reference signal transmissions in accordance with one or more aspects of the present disclosure. The communications manager 1415 may be an example of aspects of a communications manager 1215, a communications manager 1315, or a communications manager 1515 described with reference to FIGS. 12, 13, and 15. The communications manager 1415 may include MCS component 1420, constellation subset selection component 1425, modulation mapping component 1430, and phase rotation component 1435. Each of these modules may communicate, directly or indirectly, with one another (e.g., via one or more buses).

MCS component 1420 may identify a first modulation scheme having a first constellation for a first subset of transmissions in a TTI and identify a second modulation scheme having a second constellation for a second subset of transmissions in the TTI, the second constellation having fewer constellation points than the first constellation. In some cases, the identifying the first modulation scheme includes determining that the first subset of transmissions are to be transmitted using a 16 QAM or higher modulation scheme. In some cases, the identifying the second modulation scheme includes determining and the second subset of transmissions are to be transmitted using a QPSK modulation scheme. In some cases, the first modulation scheme is a 64 QAM modulation scheme and the second modulation scheme is a 16 QAM modulation scheme, and the selecting the subset of constellation points of the first constellation includes: identifying constellation points of the 64 QAM modulation scheme that have a power closest to an average power of the first constellation as the subset of constellation points of the first constellation.

Constellation subset selection component 1425 may select a subset of constellation points of the first constellation for transmitting the second subset of transmissions, the subset of constellation points corresponding to one or more constellation points of the first modulation scheme and having an average power that is the same or similar to an average constellation point power of the first constellation. In some examples, if needed, the constellation subset selection component 1425 may determine if constellation points of the first modulation scheme do not match the subset of constellation points.

Modulation mapping component 1430 may transmit the first subset of transmissions using the first modulation scheme and the second subset of transmissions using the selected subset of constellation points of the first constellation. In some examples, the modulation mapping component 1430 may coordinate alternating subsets of a first modulation scheme for the second subset of transmissions that may combine to have an average power that is the same or similar as the average power of the first modulation scheme. In some cases, a first portion of the second subset of transmissions and a second portion of the second subset of transmissions are transmitted using alternating frequency tones of the second subset of transmissions. Phase rotation component 1435 may phase rotate constellation points of the QPSK modulation scheme to match the subset of constellation points.

FIG. 15 shows a diagram of a system 1500 including a device 1505 that supports nested constellation techniques for payload-tapering, embedded control, or reference signal transmissions in accordance with one or more aspects of the present disclosure. Device 1505 may be an example of or include the components of wireless device 1205, wireless device 1305, or a UE 115 as described above, e.g., with reference to FIGS. 1, 12 and 13. Device 1505 may include components for bi-directional voice and data communications including components for transmitting and receiving communications, including UE communications manager 1515, processor 1520, memory 1525, software 1530, transceiver 1535, antenna 1540, and I/O controller 1545. These components may be in electronic communication via one or more busses (e.g., bus 1510). Device 1505 may communicate wirelessly with one or more base stations 105.

Processor 1520 may include an intelligent hardware device, (e.g., a general-purpose processor, a digital signal processor (DSP), a central processing unit (CPU), a microcontroller, an application-specific integrated circuit (ASIC), an field-programmable gate array (FPGA), a programmable logic device, a discrete gate or transistor logic component, a discrete hardware component, or any combination thereof). In some cases, processor 1520 may be configured to operate a memory array using a memory controller. In other cases, a memory controller may be integrated into processor 1520. Processor 1520 may be configured to execute computer-readable instructions stored in a memory to perform various functions (e.g., functions or tasks supporting nested constellation techniques for payload-tapering, embedded control, or reference signal transmissions).

Memory 1525 may include random access memory (RAM) and read only memory (ROM). The memory 1525 may store computer-readable, computer-executable software 1530 including instructions that, when executed, cause the processor to perform various functions described herein. In some cases, the memory 1525 may contain, among other things, a basic input/output system (BIOS) which may control basic hardware and/or software operation such as the interaction with peripheral components or devices.

Software 1530 may include code to implement aspects of the present disclosure, including code to support nested constellations for payload-tapering, embedded control, or reference signal transmissions. Software 1530 may be stored in a non-transitory computer-readable medium such as system memory or other memory. In some cases, the software 1530 may not be directly executable by the processor but may cause a computer (e.g., when compiled and executed) to perform functions described herein.

Transceiver 1535 may communicate bi-directionally, via one or more antennas, wired, or wireless links as described above. For example, the transceiver 1535 may represent a wireless transceiver and may communicate bi-directionally with another wireless transceiver. The transceiver 1535 may also include a modem to modulate the packets and provide the modulated packets to the antennas for transmission, and to demodulate packets received from the antennas.

In some cases, the wireless device may include a single antenna 1540. However, in some cases the device may have more than one antenna 1540, which may be capable of concurrently transmitting or receiving multiple wireless transmissions.

I/O controller 1545 may manage input and output signals for device 1505. I/O controller 1545 may also manage peripherals not integrated into device 1505. In some cases, I/O controller 1545 may represent a physical connection or port to an external peripheral. In some cases, I/O controller 1545 may utilize an operating system such as iOS®, ANDROID®, MS-DOS®, MS-WINDOWS®, OS/2®, UNIX®, LINUX®, or another known operating system.

FIG. 16 shows a diagram of a system 1600 including a device 1605 that supports nested constellation techniques for payload-tapering, embedded control, or reference signal transmissions in accordance with one or more aspects of the present disclosure. Device 1605 may be an example of or include the components of wireless device 1305, wireless device 1405, or a base station 105 as described above, e.g., with reference to FIGS. 1, 13 and 14. Device 1605 may include components for bi-directional voice and data communications including components for transmitting and receiving communications, including base station communications manager 1615 which may be an example of communications manager 1215 and communications manager 1315 of FIGS. 12 and 13, processor 1620, memory 1625, software 1630, transceiver 1635, antenna 1640, network communications manager 1645, and base station coordination manager 1650. These components may be in electronic communication via one or more busses (e.g., bus 1610). Device 1605 may communicate wirelessly with one or more UEs 115.

Base station coordination manager 1650 may manage communications with other base station 105, and may include a controller or scheduler for controlling communications with UEs 115 in cooperation with other base stations 105. For example, the base station coordination manager 1650 may coordinate scheduling for transmissions to UEs 115 for various interference mitigation techniques such as beamforming or joint transmission. In some examples, base station coordination manager 1650 may provide an X2 interface within an LTE/LTE-A wireless communication network technology to provide communication between base stations 105.

Processor 1620 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1620 may be configured to operate a memory array using a memory controller. In other cases, a memory controller may be integrated into processor 1620. Processor 1620 may be configured to execute computer-readable instructions stored in a memory to perform various functions (e.g., functions or tasks supporting nested constellation techniques for payload-tapering, embedded control, or reference signal transmissions).

Memory 1625 may include RAM and ROM. The memory 1625 may store computer-readable, computer-executable software 1630 including instructions that, when executed, cause the processor to perform various functions described herein. In some cases, the memory 1625 may contain, among other things, a BIOS which may control basic hardware and/or software operation such as the interaction with peripheral components or devices.

Software 1630 may include code to implement aspects of the present disclosure, including code to support nested constellations for payload-tapering, embedded control, or reference signal transmissions. Software 1630 may be stored in a non-transitory computer-readable medium such as system memory or other memory. In some cases, the software 1630 may not be directly executable by the processor but may cause a computer (e.g., when compiled and executed) to perform functions described herein.

Transceiver 1635 may communicate bi-directionally, via one or more antennas, wired, or wireless links as described above. For example, the transceiver 1635 may represent a wireless transceiver and may communicate bi-directionally with another wireless transceiver. The transceiver 1635 may also include a modem to modulate the packets and provide the modulated packets to the antennas for transmission, and to demodulate packets received from the antennas.

In some cases, the wireless device may include a single antenna 1640. However, in some cases the device may have more than one antenna 1640, which may be capable of concurrently transmitting or receiving multiple wireless transmissions.

Network communications manager 1645 may manage communications with the core network (e.g., via one or more wired backhaul links). For example, the network communications manager 1645 may manage the transfer of data communications for client devices, such as one or more UEs 115.

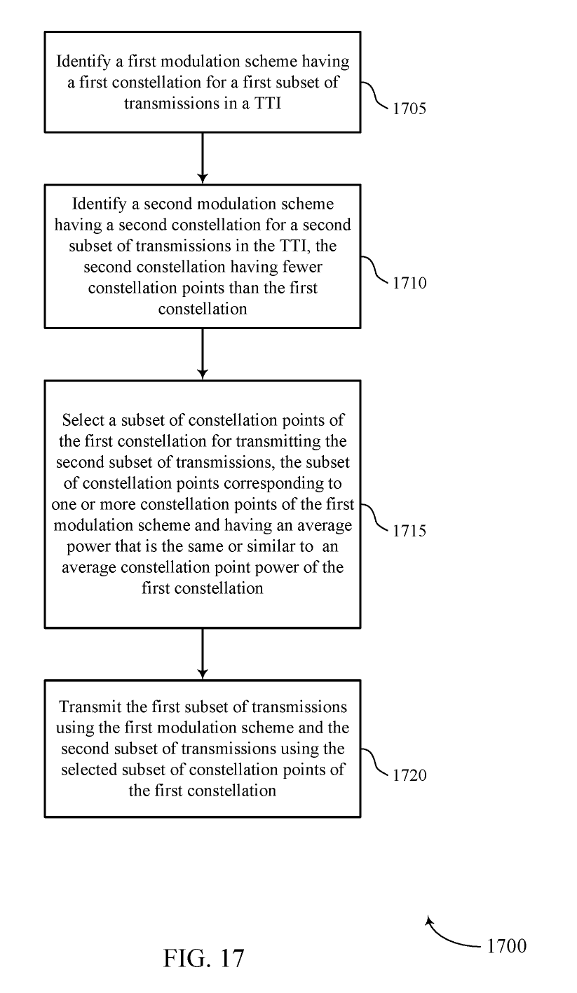

FIG. 17 shows a flowchart illustrating a method 1700 for nested constellation techniques for payload-tapering, embedded control, or reference signal transmissions in accordance with one or more aspects of the present disclosure. The operations of method 1700 may be implemented by a UE 115 or base station 105 or its components as described herein. For example, the operations of method 1700 may be performed by a communications manager as described with reference to FIGS. 12 through 14. In some examples, a UE 115 or base station 105 may execute a set of codes to control the functional elements of the device to perform the functions described below. Additionally or alternatively, the UE 115 or base station 105 may perform aspects the functions described below using special-purpose hardware.

At block 1705 the UE 115 or base station 105 may identify a first modulation scheme having a first constellation for a first subset of transmissions in a TTI. The operations of block 1705 may be performed according to the methods described with reference to FIGS. 1 through 11. In some examples, aspects of the operations of block 1705 may be performed by a MCS component as described with reference to FIGS. 12 through 14.

At block 1710 the UE 115 or base station 105 may identify a second modulation scheme having a second constellation for a second subset of transmissions in the TTI, the second constellation having fewer constellation points than the first constellation. The operations of block 1710 may be performed according to the methods described with reference to FIGS. 1 through 11. In some examples, aspects of the operations of block 1710 may be performed by a MCS component as described with reference to FIGS. 12 through 14.

At block 1715 the UE 115 or base station 105 may select a subset of constellation points of the first constellation for transmitting the second subset of transmissions, the subset of constellation points corresponding to one or more constellation points of the first modulation scheme and having an average power that is the same or similar to an average constellation point power of the first constellation. The operations of block 1715 may be performed according to the methods described with reference to FIGS. 1 through 11. In some examples, aspects of the operations of block 1715 may be performed by a constellation subset selection component as described with reference to FIGS. 12 through 14.

At block 1720 the UE 115 or base station 105 may transmit the first subset of transmissions using the first modulation scheme and the second subset of transmissions using the selected subset of constellation points of the first constellation. The operations of block 1720 may be performed according to the methods described with reference to FIGS. 1 through 11. In some examples, aspects of the operations of block 1720 may be performed by a modulation mapping component as described with reference to FIGS. 12 through 14.

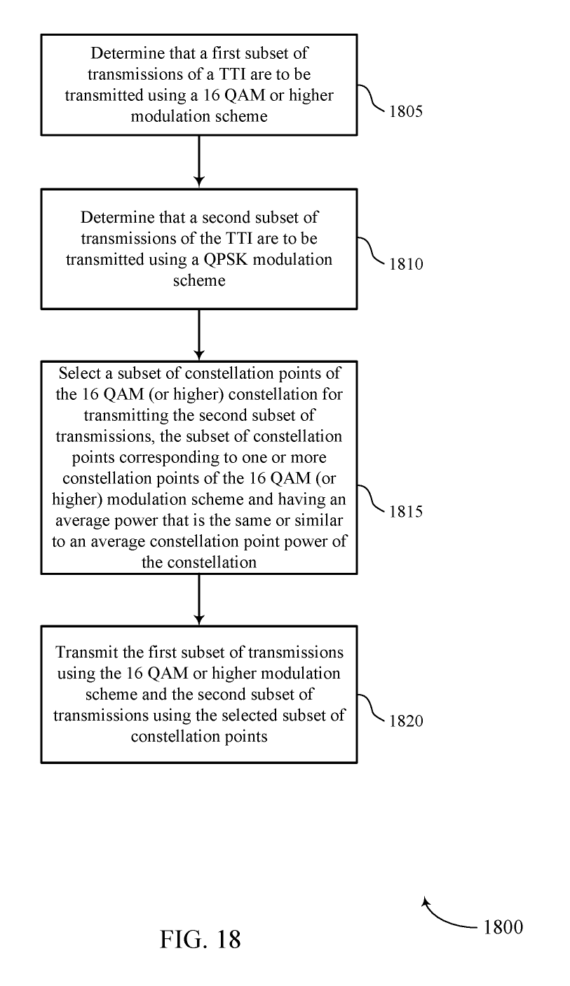

FIG. 18 shows a flowchart illustrating a method 1800 for nested constellation techniques for payload-tapering, embedded control, or reference signal transmissions in accordance with one or more aspects of the present disclosure. The operations of method 1800 may be implemented by a UE 115 or base station 105 or its components as described herein. For example, the operations of method 1800 may be performed by a communications manager as described with reference to FIGS. 12 through 14. In some examples, a UE 115 or base station 105 may execute a set of codes to control the functional elements of the device to perform the functions described below. Additionally or alternatively, the UE 115 or base station 105 may perform aspects the functions described below using special-purpose hardware.

At block 1805 the UE 115 or base station 105 may determine that a first subset of transmissions of a TTI are to be transmitted using a 16 QAM or higher modulation scheme. The operations of block 1805 may be performed according to the methods described with reference to FIGS. 1 through 11. In some examples, aspects of the operations of block 1805 may be performed by a MCS component as described with reference to FIGS. 12 through 14.

At block 1810 the UE 115 or base station 105 may determine that a second subset of transmissions of the TTI are to be transmitted using a QPSK modulation scheme. The operations of block 1810 may be performed according to the methods described with reference to FIGS. 1 through 11. In some examples, aspects of the operations of block 1810 may be performed by a MCS component as described with reference to FIGS. 12 through 14.

At block 1815 the UE 115 or base station 105 may select a subset of constellation points of the 16 QAM (or higher) constellation for transmitting the second subset of transmissions, the subset of constellation points corresponding to one or more constellation points of the 16 QAM (or higher) modulation scheme and having an average power that is the same or similar to an average constellation point power of the constellation. The operations of block 1815 may be performed according to the methods described with reference to FIGS. 1 through 11. In some examples, aspects of the operations of block 1815 may be performed by a constellation subset selection component as described with reference to FIGS. 12 through 14.

At block 1820 the UE 115 or base station 105 may transmit the first subset of transmissions using the 16 QAM or higher modulation scheme and the second subset of transmissions using the selected subset of constellation points. The operations of block 1820 may be performed according to the methods described with reference to FIGS. 1 through 11. In some examples, aspects of the operations of block 1820 may be performed by a modulation mapping component as described with reference to FIGS. 12 through 14.

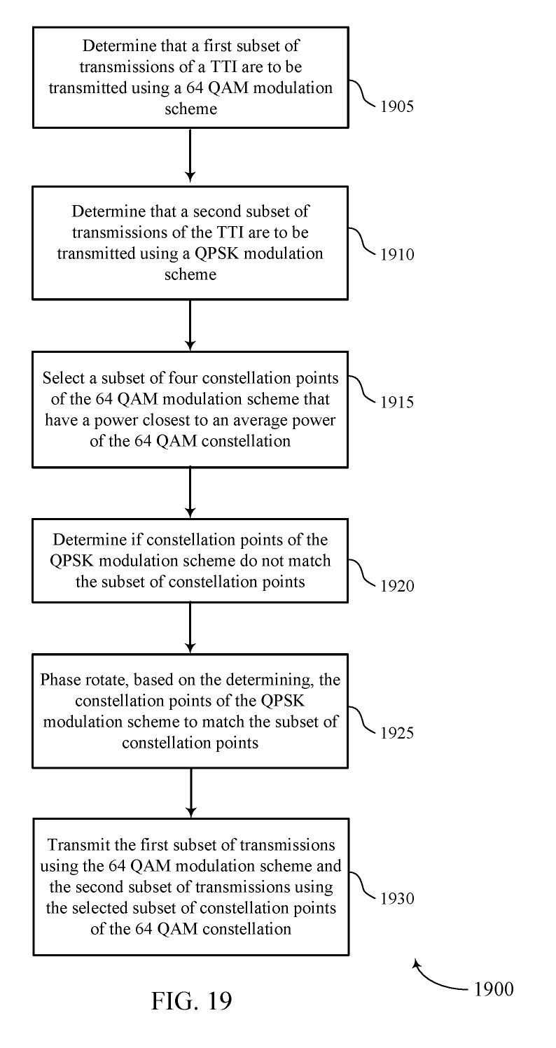

FIG. 19 shows a flowchart illustrating a method 1900 for nested constellation techniques for payload-tapering, embedded control, or reference signal transmissions in accordance with one or more aspects of the present disclosure. The operations of method 1900 may be implemented by a UE 115 or base station 105 or its components as described herein. For example, the operations of method 1900 may be performed by a communications manager as described with reference to FIGS. 12 through 14. In some examples, a UE 115 or base station 105 may execute a set of codes to control the functional elements of the device to perform the functions described below. Additionally or alternatively, the UE 115 or base station 105 may perform aspects the functions described below using special-purpose hardware.

At block 1905 the UE 115 or base station 105 may determine that a first subset of transmissions of a TTI are to be transmitted using a 64 QAM modulation scheme. The operations of block 1905 may be performed according to the methods described with reference to FIGS. 1 through 11. In some examples, aspects of the operations of block 1905 may be performed by a MCS component as described with reference to FIGS. 12 through 14.

At block 1910 the UE 115 or base station 105 may determine that a second subset of transmissions of the TTI are to be transmitted using a QPSK modulation scheme. The operations of block 1910 may be performed according to the methods described with reference to FIGS. 1 through 11. In some examples, aspects of the operations of block 1910 may be performed by a MCS component as described with reference to FIGS. 12 through 14.

At block 1915 the UE 115 or base station 105 may select a subset of four constellation points of the 64 QAM modulation scheme that have a power closest to an average power of the 64 QAM constellation. The operations of block 1915 may be performed according to the methods described with reference to FIGS. 1 through 11. In some examples, aspects of the operations of block 1915 may be performed by a constellation subset selection component as described with reference to FIGS. 12 through 14.

At block 1920 the UE 115 or base station 105 may determine if constellation points of the QPSK modulation scheme do not match the subset of constellation points. The operations of block 1920 may be performed according to the methods described with reference to FIGS. 1 through 11. In some examples, aspects of the operations of block 1920 may be performed by a modulation mapping component as described with reference to FIGS. 12 through 14.

At block 1925 the UE 115 or base station 105 may phase rotate, based on the determining, the constellation points of the QPSK modulation scheme to match the subset of constellation points. The operations of block 1925 may be performed according to the methods described with reference to FIGS. 1 through 11. In some examples, aspects of the operations of block 1925 may be performed by a phase rotation component as described with reference to FIGS. 12 through 14.

At block 1930 the UE 115 or base station 105 may transmit the first subset of transmissions using the 64 QAM modulation scheme and the second subset of transmissions using the selected subset of constellation points of the 64 QAM constellation. The operations of block 1930 may be performed according to the methods described with reference to FIGS. 1 through 11. In some examples, aspects of the operations of block 1930 may be performed by a modulation mapping component as described with reference to FIGS. 12 through 14.

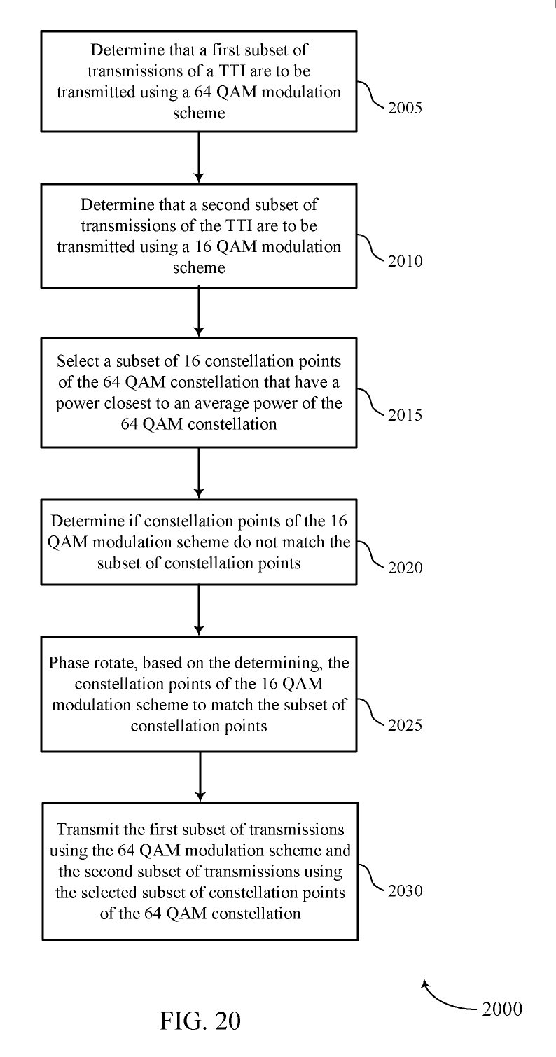

FIG. 20 shows a flowchart illustrating a method 2000 for nested constellation techniques for payload-tapering, embedded control, or reference signal transmissions in accordance with one or more aspects of the present disclosure. The operations of method 2000 may be implemented by a UE 115 or base station 105 or its components as described herein. For example, the operations of method 2000 may be performed by a communications manager as described with reference to FIGS. 12 through 14. In some examples, a UE 115 or base station 105 may execute a set of codes to control the functional elements of the device to perform the functions described below. Additionally or alternatively, the UE 115 or base station 105 may perform aspects the functions described below using special-purpose hardware.

At block 2005 the UE 115 or base station 105 may determine that a first subset of transmissions of a TTI are to be transmitted using a 64 QAM modulation scheme. The operations of block 2005 may be performed according to the methods described with reference to FIGS. 1 through 11. In some examples, aspects of the operations of block 2005 may be performed by a MCS component as described with reference to FIGS. 12 through 14.

At block 2010 the UE 115 or base station 105 may determine that a second subset of transmissions of the TTI are to be transmitted using a 16 QAM modulation scheme. The operations of block 2010 may be performed according to the methods described with reference to FIGS. 1 through 11. In some examples, aspects of the operations of block 2010 may be performed by a MCS component as described with reference to FIGS. 12 through 14.

At block 2015 the UE 115 or base station 105 may select a subset of 16 constellation points of the 64 QAM constellation that have a power closest to an average power of the 64 QAM constellation. The operations of block 2015 may be performed according to the methods described with reference to FIGS. 1 through 11. In some examples, aspects of the operations of block 2015 may be performed by a constellation subset selection component as described with reference to FIGS. 12 through 14.

At block 2020 the UE 115 or base station 105 may determine if constellation points of the 16 QAM modulation scheme do not match the subset of constellation points. The operations of block 2020 may be performed according to the methods described with reference to FIGS. 1 through 11. In some examples, aspects of the operations of block 2020 may be performed by a constellation subset selection component as described with reference to FIGS. 12 through 14.

At block 2025 the UE 115 or base station 105 may phase rotate, based on the determining, the constellation points of the 16 QAM modulation scheme to match the subset of constellation points. The operations of block 2025 may be performed according to the methods described with reference to FIGS. 1 through 11. In some examples, aspects of the operations of block 2025 may be performed by a phase rotation component as described with reference to FIGS. 12 through 14.

At block 2030 the UE 115 or base station 105 may transmit the first subset of transmissions using the 64 QAM modulation scheme and the second subset of transmissions using the selected subset of constellation points of the 64 QAM constellation. The operations of block 2030 may be performed according to the methods described with reference to FIGS. 1 through 11. In some examples, aspects of the operations of block 2030 may be performed by a modulation mapping component as described with reference to FIGS. 12 through 14.

It should be noted that the methods described above describe possible implementations, and that the operations may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP LTE and LTE-A are releases of Universal Mobile Telecommunications System (UMTS) that use E-UTRA. UTRA, E-UTRA, UMTS, LTE, LTE-A, and Global System for Mobile communications (GSM) are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects an LTE system may be described for purposes of example, and LTE terminology may be used in much of the description, the techniques described herein are applicable beyond LTE applications.

In LTE/LTE-A networks, including such networks described herein, the term evolved node B (eNB) may for example be used to describe the base stations. The wireless communications system or systems described herein may include a heterogeneous LTE/LTE-A network in which different types of eNBs provide coverage for various geographical regions. For example, each eNB or base station may provide communication coverage for a macro cell, a small cell, or other types of cell. The term “cell” may be used to describe a base station, a carrier or component carrier associated with a base station, or a coverage area (e.g., sector, etc.) of a carrier or base station, depending on context.

Base stations may include or may be referred to by those skilled in the art as a base transceiver station, a radio base station, an access point, a radio transceiver, a NodeB, eNB, Home NodeB, a Home eNodeB, or some other suitable terminology. The geographic coverage area for a base station may be divided into sectors making up a portion of the coverage area. The wireless communications system or systems described herein may include base stations of different types (e.g., macro or small cell base stations). The UEs described herein may be able to communicate with various types of base stations and network equipment including macro eNBs, small cell eNBs, relay base stations, and the like. There may be overlapping geographic coverage areas for different technologies.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a CSG, UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers). A UE may be able to communicate with various types of base stations and network equipment including macro eNBs, small cell eNBs, relay base stations, and the like.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 and communications system 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Additionally or alternatively, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Additionally or alternatively, as used herein, including in the claims, “or” as used in a list of items (for example, a list of items prefaced by a phrase such as “at least one of” or “one or more of”) indicates an inclusive list such that, for example, a phrase referring to “at least one of” a list of items refers to any combination of those items, including single members. As an example, “at least one of: A, B, or C” is intended to cover A, B, C, A-B, A-C, B-C, and A-B-C, as well as any combination with multiples of the same element (e.g., A-A A-A-A, A-A-B, A-A-C, A-B-B, A-C-C, B-B, B-B-B, B-B-C, C-C, and C-C-C or any other ordering of A, B, and C). As used herein, the phrase “based on” shall not be construed as a reference to a closed set of conditions. For example, an exemplary operation that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication, comprising:
identifying a first modulation scheme having a first constellation for a first subset of transmissions in a transmission time interval (TTI);
identifying a second modulation scheme having a second constellation for a second subset of transmissions in the TTI, the second constellation having fewer constellation points than the first constellation;
selecting a subset of constellation points of the first constellation for transmitting the second subset of transmissions, the subset of constellation points corresponding to one or more constellation points of the first modulation scheme and having an average power that is the same or similar to an average constellation point power of the first constellation; and
transmitting the first subset of transmissions using the first modulation scheme and the second subset of transmissions using the selected subset of constellation points of the first constellation.

2. The method of claim 1, wherein
the first subset of transmissions comprise data transmissions and the second subset of transmissions comprise a payload-tapered transmission.

3. The method of claim 1, wherein
the first subset of transmissions comprise data transmissions, and the second subset of transmissions comprise one or more of a reference signal transmission, a control signal transmission, or any combination thereof.

4. The method of claim 1, wherein
the identifying the first modulation scheme comprises determining that the first subset of transmissions are to be transmitted using a 16 quadrature amplitude multiplexing (QAM) or higher modulation scheme; and
the identifying the second modulation scheme comprises determining that the second subset of transmissions are to be transmitted using a quadrature phase shift keying (QPSK) modulation scheme.

5. The method of claim 4, wherein
the first modulation scheme is a 16 QAM modulation scheme, and the selecting the subset of constellation points of the first constellation comprises:
identifying constellation points of the 16 QAM modulation scheme that have a same power as an average power of the first constellation as the subset of constellation points of the first constellation; and
phase rotating constellation points of the QPSK modulation scheme to match the subset of constellation points.

6. The method of claim 1, wherein
the first modulation scheme is a 64 QAM modulation scheme, and the selecting the subset of constellation points of the first constellation comprises:
identifying constellation points of the 64 QAM modulation scheme that have a power closest to an average power of the first constellation as the subset of constellation points of the first constellation;
determining if constellation points of the QPSK modulation scheme do not match the subset of constellation points; and
phase rotating, based at least in part on the determining, the constellation points of the QPSK modulation scheme to match the subset of constellation points.

7. The method of claim 6, wherein
the identifying constellation points of the 64 QAM modulation scheme comprises:
identifying a first subset of constellation points of the 64 QAM modulation scheme and a second subset of constellation points of the 64 QAM modulation scheme that have a combined average power that is the same as an average power of the first constellation;
selecting the first subset of constellation points of the 64 QAM modulation scheme for a first portion of the second subset of transmissions; and
selecting the second subset of constellation points of the 64 QAM modulation scheme for a second portion of the second subset of transmissions.

8. The method of claim 7, wherein
the first portion of the second subset of transmissions and the second portion of the second subset of transmissions are transmitted using alternating frequency tones of the second subset of transmissions.

9. The method of claim 1, wherein
the first modulation scheme is a 64 quadrature amplitude multiplexing (QAM) modulation scheme and the second modulation scheme is a 16 QAM modulation scheme, and the selecting the subset of constellation points of the first constellation comprises:
identifying constellation points of the 64 QAM modulation scheme that have a power closest to an average power of the first constellation as the subset of constellation points of the first constellation;
determining if constellation points of the 16 QAM modulation scheme do not match the subset of constellation points; and
phase rotating, based at least in part on the determining, the constellation points of the 16 QAM modulation scheme to match the subset of constellation points.

10. The method of claim 1, wherein
the method is performed by a base station and the first subset of transmissions and the second subset of transmissions are transmitted to a user equipment.

11. The method of claim 1, wherein
the method is performed by a user equipment (UE) and the first subset of transmissions and the second subset of transmissions are transmitted to a base station or another UE.

12. An apparatus for wireless communication, comprising:
a processor;
memory in electronic communication with the processor; and
the processor and memory configured to:
identify a first modulation scheme having a first constellation for a first subset of transmissions in a transmission time interval (TTI);
identify a second modulation scheme having a second constellation for a second subset of transmissions in the TTI, the second constellation having fewer constellation points than the first constellation;
select a subset of constellation points of the first constellation for transmitting the second subset of transmissions, the subset of constellation points corresponding to one or more constellation points of the first modulation scheme and having an average power that is the same or similar to an average constellation point power of the first constellation; and
transmit the first subset of transmissions using the first modulation scheme and the second subset of transmissions using the selected subset of constellation points of the first constellation.

13. The apparatus of claim 12, wherein
the first subset of transmissions comprise data transmissions and the second subset of transmissions comprise a payload-tapered transmission.

14. The apparatus of claim 12, wherein
the first subset of transmissions comprise data transmissions, and the second subset of transmissions comprise one or more of a reference signal transmission, a control signal transmission, or any combination thereof.

15. The apparatus of claim 12, wherein the processor and memory are further configured to:
determine that the first subset of transmissions are to be transmitted using a 16 quadrature amplitude multiplexing (QAM) or higher modulation scheme; and
determine that the second subset of transmissions are to be transmitted using a quadrature phase shift keying (QPSK) modulation scheme.

16. The apparatus of claim 15, wherein
the first modulation scheme is a 16 QAM modulation scheme, and the processor and memory are further configured to:
identify constellation points of the 16 QAM modulation scheme that have a same power as an average power of the first constellation as the subset of constellation points of the first constellation; and
phase rotate constellation points of the QPSK modulation scheme to match the subset of constellation points.

17. The apparatus of claim 12, wherein
the first modulation scheme is a 64 QAM modulation scheme, and the processor and memory are further configured to:
identify constellation points of the 64 QAM modulation scheme that have a power closest to an average power of the first constellation as the subset of constellation points of the first constellation;
determine if constellation points of the QPSK modulation scheme do not match the subset of constellation points; and
phase rotate, based at least in part on the determining, the constellation points of the QPSK modulation scheme to match the subset of constellation points.

18. The apparatus of claim 17, wherein the processor and memory are further configured to:
identify a first subset of constellation points of the 64 QAM modulation scheme and a second subset of constellation points of the 64 QAM modulation scheme that have a combined average power that is the same as an average power of the first constellation;
select the first subset of constellation points of the 64 QAM modulation scheme for a first portion of the second subset of transmissions; and
select the second subset of constellation points of the 64 QAM modulation scheme for a second portion of the second subset of transmissions.

19. The apparatus of claim 18, wherein
the first portion of the second subset of transmissions and the second portion of the second subset of transmissions are transmitted using alternating frequency tones of the second subset of transmissions.

20. The apparatus of claim 12, wherein
the first modulation scheme is a 64 quadrature amplitude multiplexing (QAM) modulation scheme and the second modulation scheme is a 16 QAM modulation scheme, and the processor and memory are further configured to:
identify constellation points of the 64 QAM modulation scheme that have a power closest to an average power of the first constellation as the subset of constellation points of the first constellation;
determine if constellation points of the 16 QAM modulation scheme do not match the subset of constellation points; and
phase rotate, based at least in part on the determining, the constellation points of the 16 QAM modulation scheme to match the subset of constellation points.

21. The apparatus of claim 12, wherein
the processor and memory are further configured to perform at a base station and the first subset of transmissions and the second subset of transmissions are transmitted to a user equipment.

22. The apparatus of claim 12, wherein
the processor and memory are further configured to perform at a user equipment (UE) and the first subset of transmissions and the second subset of transmissions are transmitted to a base station or another UE.

23. An apparatus for wireless communication, comprising:
means for identifying a first modulation scheme having a first constellation for a first subset of transmissions in a transmission time interval (TTI);
means for identifying a second modulation scheme having a second constellation for a second subset of transmissions in the TTI, the second constellation having fewer constellation points than the first constellation;
means for selecting a subset of constellation points of the first constellation for transmitting the second subset of transmissions, the subset of constellation points corresponding to one or more constellation points of the first modulation scheme and having an average power that is the same or similar to an average constellation point power of the first constellation; and
means for transmitting the first subset of transmissions using the first modulation scheme and the second subset of transmissions using the selected subset of constellation points of the first constellation.

24. The apparatus of claim 23, wherein
the first subset of transmissions comprise data transmissions and the second subset of transmissions comprise a payload-tapered transmission.

25. The apparatus of claim 23, wherein
the first subset of transmissions comprise data transmissions, and the second subset of transmissions comprise one or more of a reference signal transmission, a control signal transmission, or any combination thereof.

26. The apparatus of claim 23, wherein
the means for identifying the first modulation scheme comprises means for determining that the first subset of transmissions are to be transmitted using a 16 quadrature amplitude multiplexing (QAM) or higher modulation scheme; and
the means for identifying the second modulation scheme comprises means for determining that the second subset of transmissions are to be transmitted using a quadrature phase shift keying (QPSK) modulation scheme.

27. A non-transitory computer-readable medium storing code for wireless communications, the code comprising instructions executable to:
identify a first modulation scheme having a first constellation for a first subset of transmissions in a transmission time interval (TTI);
identify a second modulation scheme having a second constellation for a second subset of transmissions in the TTI, the second constellation having fewer constellation points than the first constellation;
select a subset of constellation points of the first constellation for transmitting the second subset of transmissions, the subset of constellation points corresponding to one or more constellation points of the first modulation scheme and having an average power that is the same or similar to an average constellation point power of the first constellation; and
transmit the first subset of transmissions using the first modulation scheme and the second subset of transmissions using the selected subset of constellation points of the first constellation.

28. The non-transitory computer-readable medium of claim 27, wherein
the first subset of transmissions comprise data transmissions and the second subset of transmissions comprise a payload-tapered transmission.

29. The non-transitory computer-readable medium of claim 27, wherein
the first subset of transmissions comprise data transmissions, and the second subset of transmissions comprise one or more of a reference signal transmission, a control signal transmission, or any combination thereof.

30. The non-transitory computer-readable medium of claim 27, wherein the instructions are further executable to:
determine that the first subset of transmissions are to be transmitted using a 16 quadrature amplitude multiplexing (QAM) or higher modulation scheme; and
determine that the second subset of transmissions are to be transmitted using a quadrature phase shift keying (QPSK) modulation scheme.
